(19) United States
(12) Patent Application Publication
(10) Pub. No.: US 2018/0174103 A1
(43) Pub. Date: Jun. 21, 2018

(54) IDEATION PLATFORM SYSTEM AND METHOD

(71) Applicant: IDEATION6 SOLUTIONS INC., Montreal (CA)

(72) Inventor: Francois Auger, Montreal (CA)

(73) Assignee: IDEATION6 SOLUTIONS INC., Montreal, QC (CA)

(21) Appl. No.: 15/737,101

(22) PCT Filed: Jun. 17, 2016
(86) PCT No.: PCT/CA2016/050715

§ 371 Date: Dec. 15, 2017

Related U.S. Application Data
(60) Provisional application No. 62/180,645, filed on Jun. 17, 2015.

(51) Int. Cl. G06Q 10/10; G06F 3/0481; G06F 3/0484

(52) U.S. Cl. CPC G06Q 10/101; G06Q 10/103; G06F 3/04842; G06F 3/04817

(57) ABSTRACT

A method for collaborative ideation is provided. The method uses a plurality of network-connected processor-based devices operated by collaborates separated into teams. The devices have display screens, and the method involves providing thereon: an idea creation graphical user interface (GUI) allowing collaborators to individually describe ideas; an idea enrichment GUI allowing collaborators to add or modify facets of the individual ideas; a facet evaluation GUI allowing collaborators to vote on a pertinence of each of the facets of an idea; and an idea selection GUI allowing the collaborators to select at least one final idea. A system for providing a collaborative ideation platform and a non-transient computer readable medium for providing the ideation platform on a computer are also provided.

### TECHNICAL FIELD

The present invention relates to the field of ideation and more particularly, to tools for capturing the results of an ideation process and the ideation process itself.

### BACKGROUND

Ideation is the creative process of generating, developing, and communicating new ideas. Many software products exist for this purpose, in order to solve key business challenges efficiently. They are sometimes called idea management software, social-collaboration software, innovation management tools, mind-mapping tools, or business innovation software. They are designed to add structure to the ideation process, to encourage greater participation, to improve the quality of ideas generated, and to support an innovation culture.

There is a need to improve on the available tools for ideation in order to allow individuals more facility with regards to collaborating and assembling information into a coherent whole that may be viewed as an idea.

### SUMMARY

According to an aspect of the invention, there is provided a method for collaborative ideation. The method uses a plurality of network-connected processor-based devices having display screens, where each processor-based device is operated by one of a plurality of collaborators organized into one or more teams. The method comprises the steps of:
a) providing an idea creation graphical user interface (GUI) on the display screens of the processor-based devices, allowing the collaborators to individually describe ideas through the creation of facets comprising digital files in a plurality of expression formats;
b) receiving facets created by each of the collaborators and associating at least some of said facets to form individual ideas;
c) providing an idea enrichment GUI on the display screens of the processor-based devices in a team, displaying the individual ideas created by said team one at a time, and allowing the collaborators in the team to add or modify facets of the individual ideas created by each collaborator of the team to enrich said individual ideas and form enriched ideas;
d) providing a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
e) receiving votes from the collaborators scoring each of the facets of each of the enriched ideas, and determining facets which are below a predetermined pertinence threshold; and
f) providing an idea selection GUI on the display screen of at least one of the processor-based devices in each team, displaying the enriched ideas while hiding the facets determined to be below the predetermined pertinence threshold, and allowing the collaborators in each team to select at least one final idea from the enriched individual ideas created by their team.

In possible embodiments of the method, the step of displaying each of the facets forming the enriched idea comprises displaying a visual summary of each facet separately in a form of a widget, the widget being selectable to allow access to detailed contents of the facet.

In possible embodiments of the method, the step of displaying the enriched ideas comprises displaying a visual summary of the enriched ideas, the visual summary comprising a visual indication of a total number of facets of each expression format used to form the enriched ideas.

In some embodiments of the method, the step of displaying an enriched idea on the display screen comprises grouping together facets corresponding to a same expression format, synthesizing the enriched idea into a three-dimensional (3D) geometric shape using the facets, with each face of the 3D geometric shape comprising one group of facets of the same expression format, and displaying the 3D geometric shape on the display screen.

In some embodiments of the method, each face of the geometric shape is selectable and, upon selecting a face, each of the facets in the group of facets corresponding to said face are displayed separately on the display screen. Preferably, the expression formats include at least the following formats: text, photos, documents, audio, video, and hyperlinks.

In some embodiments of the method, the idea enrichment GUI displays each of the facets forming the individual ideas on each of the processor-based devices, the idea enrichment GUI updating the display of each of the facets on all of the processor-based devices in real time, as facets are added or modified on any one the processor-based devices.

In some embodiments of the method, in step a), the idea creation GUI allows collaborators to respectively create individual ideas concurrently with other collaborators.

In some embodiments of the method, the facet evaluation GUI allows collaborators to respectively vote on each of the facets forming the enriched ideas, concurrently with other collaborators. Preferably, in step d), the facet evaluation GUI is personalized on each of the processor-based devices, whereby the facet evaluation GUI only allows voting on facets created or modified by collaborators on other ones of the processor-based devices. Still preferably, the method may further comprise a step of, for each team, submitting the at least one final idea to a jury for evaluation or selection among final ideas submitted by all teams.

In some embodiments of the method, the method may further comprise the step of, prior to step f), providing an idea modification GUI on the display screen of at least one of the processor-based devices, the idea modification GUI allowing enriched ideas to be modified or duplicated.

In some embodiments of the method, upon modifying or duplicating an enriched idea, a copy of said enriched idea is stored in an idea database for subsequent use or searching.

In some embodiments of the method, steps a) or c) further may comprise providing an idea editing GUI on the display of the processor-based devices, the idea editing GUI allowing facets of individual or enriched ideas to be selectively modified, duplicated or hidden. Preferably, the idea editing GUI may further allow individual facets to be enhanced by adding sub-facets thereto.

In some embodiments of the method, in steps a) or c), the idea creation and enrichment GUIs can allow collaborators to create facets which are stored in a facet database, and allows collaborators to select which of their stored facets to add to individual or enriched ideas.

In some embodiments, the method may further comprise the step of, prior to step f), providing an idea evaluation GUI on each of the processor-based devices, the idea evaluation GUI displaying the enriched ideas one at a time while hiding the facets determined to be below the predetermined pertinence threshold, and allowing each of the collaborators in the team to numerically vote on predetermined qualities of each of the enriched ideas as a whole, wherein step f) comprises ranking the enriched ideas according to an overall numerical vote by the team, and displaying the enriched ideas for selection ordered by said ranking.

In some embodiments of the method, step f) can further comprise allowing a team leader to provide a holistic evaluation of each of the enriched ideas, ranking the enriched ideas according to the holistic evaluation, and displaying the enriched ideas for selection ordered by said ranking.

In some embodiments of the method, a global time restriction can be imposed on the collaborators for completing all of steps a) through f). It is also possible to impose individual time restrictions for completing at least some of steps a) through f) individually. In some embodiments, the time restrictions are displayed in real-time for each team in the GUIs.

In some embodiments of the method, it is possible to display each of the facets forming the individual or enriched ideas by color-coding the facets according to their expression format.

According to another aspect of the invention, a system for providing a collaborative ideation platform is provided. The platform can be accessed by a plurality of network-connected processor-based devices having display screens, each processor-based device being operated by one of a plurality of collaborators organized into teams. The system comprises a server having a processor and memory comprising:
an idea creation module configured to provide an idea creation GUI on the display screen of the processor-based devices, allowing the collaborators to individually describe ideas through the creation of facets comprising digital files in a plurality of expression formats;
an idea storage module configured to receive facets created by the collaborators, associate said facets to form individual ideas, and store the facets and the individual ideas in a database;
an idea enrichment module configured to provide an idea enrichment GUI on the display screens of the processor-based devices in a team, displaying the individual ideas created by said team one at a time, and allowing the collaborators in the team to add or modify facets of the individual ideas created by the team to enrich said individual ideas and form enriched ideas;
a facet evaluation module configured to provide a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
a ranking module configured to receive votes from the collaborators scoring each of the facets of each of the enriched ideas, and determine facets which are below a predetermined pertinence threshold; and
an idea selection module configured to provide an idea selection GUI on the display screen of at least one of the processor-based devices in each team, displaying the enriched ideas while hiding facets determined to be below the predetermined pertinence threshold, and allowing the collaborators in each team to select at least one final idea from the individual ideas created by their team.

Still according to another aspect of the invention, a non-transient computer readable medium having stored thereon instructions for causing a computer to:
provide an idea creation GUI on display screens of a plurality of network-connected processor-based devices, each processor-based device being operated by one of a plurality of collaborators organized into teams, the idea creation GUI allowing the collaborators to describe ideas through the creation of facets comprising digital files in a plurality of expression formats;
receive facets created by the collaborators, associate said facets to form individual ideas, and store the facets and the individual ideas in a database;
provide an idea enrichment GUI on the display screens of the processor-based devices in a team, displaying the individual ideas created by said team one at a time, and allowing the collaborators in the team to add or modify facets of the individual ideas created by the team to enrich said individual ideas and form enriched ideas;
provide a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
receive votes from the collaborators scoring each of the facets of each of the enriched ideas, and determine facets which are below a predetermined pertinence threshold; and
provide an idea selection GUI on the display screen of at least one of the processor-based devices in each team, displaying the enriched ideas while hiding facets determined to be below the predetermined pertinence threshold, and allowing the collaborators in each team to select at least one final idea from the individual ideas created by their team.

Of course, other processing steps may be performed prior, during or after the above described steps. The order of the steps may also differ, and some of the steps may be combined.

### BRIEF DESCRIPTION OF THE DRAWINGS

Further features and advantages of the present invention will become apparent from the following detailed description, taken in combination with the appended drawings, in which:

FIG. 1 illustrates an exemplary set of expression formats;

FIG. 2 is a schematic of the basic concept of the ideation platform;

FIG. 3 is a flowchart of an exemplary method for providing an ideation platform;

FIGS. 4A to 4C are exemplary screenshots of an idea creation GUI, allowing users to describe individual ideas in different expression formats through the creation of facets;

FIGS. 5A to 5F are exemplary graphical elements for entering data to create facets of different expression formats;

FIG. 6 is an exemplary screenshot of a facet toolbox, allowing users to access and use previously created facets;

FIGS. 7A and 7B are exemplary screenshots of the idea creation GUI, showing exemplary visual summaries of facets which represent an expressed idea;

FIG. 7C is an exemplary screenshot showing a user interface element for displaying the contents of an enriched parent facet alongside visual summaries of its child facets;

FIGS. 8A and 8B are exemplary screenshots of the idea creation GUI, showing an exemplary visual summary of an individual idea;

FIGS. 9A and 9B are exemplary screenshots of an idea enrichment GUI, allowing users to enrich the ideas of others through the addition or modification of facets;

FIG. 9C is an exemplary screenshot of a facet evaluation GUI, allowing users to vote on a pertinence of facets of an enriched idea;

FIGS. 9D and 9E are exemplary screenshots of an idea evaluation GUI, showing the display of a visual summary of the enriched idea, including the display of the idea as a geometric shape, and allowing users to vote on predetermined qualities of the enriched idea;

FIGS. 10A and 10B are exemplary screenshots of an idea modification GUI, showing the display of visual summaries of enriched ideas created by members of a team, and allowing users to modify those enriched idea;

FIGS. 11 and 12 are exemplary screenshots of an idea selection GUI, allowing users to rate ideas holistically, and select a final idea for submission;

FIG. 13 is an exemplary screenshot of a combination page in the idea modification GUI, for creating a new idea by combining existing ideas;

FIG. 14 is an exemplary screenshot of a facet combination page in the idea modification GUI, showing selection of facets from submitted ideas;

FIGS. 15A and 15B are exemplary screenshots of an animator GUI, allowing animators to have a high level view of the ideation process in progress by different teams, and allowing animators to communicate with teams;

FIG. 16 is an exemplary screenshot of the animator GUI, allowing an animator to explore an enriched idea created by one of the teams;

FIG. 17 is a block diagram of an exemplary system comprising the ideation platform;

FIG. 18 is a block diagram of an exemplary embodiment of the ideation platform; and

FIG. 19 is a block diagram of an exemplary embodiment of an application running on a processor of FIG. 18.

It will be noted that throughout the appended drawings, like features are identified by like reference numerals.

### DETAILED DESCRIPTION

There is described herein an ideation platform and method which facilitate the expression and refinement of ideas in a collaborative environment. The platform allows for multiple users to work together in order to collectively create and enrich ideas, preferably within a predetermined timeframe, such that the ideation process can be viewed as a challenge for the users. Users (also referred to as collaborators or participants) work individually in order to describe ideas in various different manners. Once an idea has been fully described, the idea can be visualized, enhanced, and evaluated by teammates. The same process is repeated for ideas created by teammates, to eventually select the best idea for submission. Preferably, different teams participate to an ideation challenge at the same time (concurrently). The platform not only provides the tools to create the ideas, it also allow users, to enrich, select, and submits ideas, and also allows other users (such as facilitators or managers) to monitor and control the process.

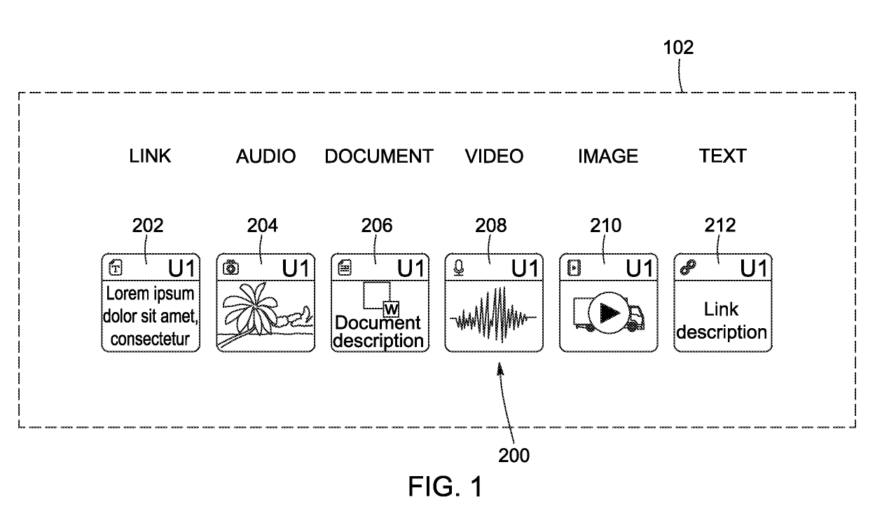

Briefly described, the platform allows for ideas to be expressed by means of facets having various expression formats corresponding to different types of digital files. As illustrated in FIG. 1, an idea may be expressed using a plurality of expression formats 102. Each expression of the idea using one of the expression formats 102 is referred to as a facet 200, and can be represented as a widget (such as an icon, a tile or a graphical representation) on a user interface of the platform with which users can interact. In the present embodiment, the facets 200 are represented as tile widgets. In other embodiments, other types of icons could be used. As can be appreciated, users can define and reshape ideas through the creation and manipulation of customizable facets 200. As illustrated, these facets can include one or several text facets 202, picture facets 204, document facets 206, audio facets 208, video facets 210, or link facets 212.

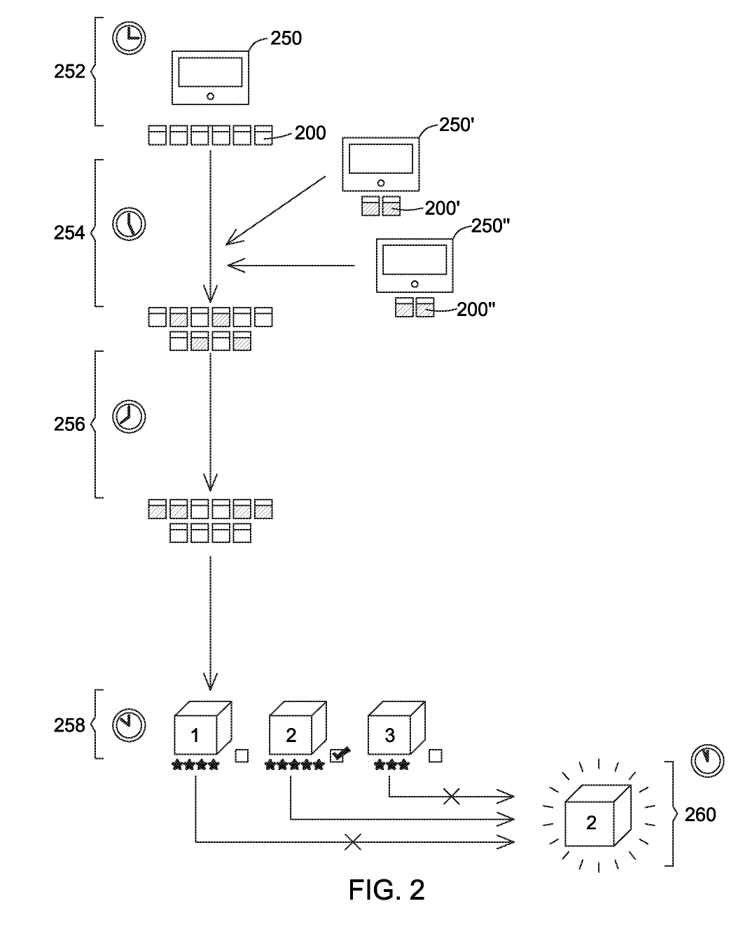

A general concept of the ideation platform is schematically illustrated in FIG. 2. The platform provides workspaces, also referred to as graphical user interfaces (GUIs), on a plurality of processor-based devices 250, 250′, 250″. The GUI allows a plurality of collaborators (which can be grouped in one or more teams) to interact with the platform to carry out tasks individually or collectively as part of a team. Broadly described, the tasks include: Creation 252, Enrichment 254, Modification 256, Selection 258 and Submission 260. The Creation task 252 involves creating an idea on one of the devices 250 using facets 200. The Enrichment task 254 involves having others contribute to the idea, for example through the addition of more facets 200′, 200″ using their devices 250′, 250″. The Modification task 256 involves making changes to the idea as a team, for example through changing or removing facets. The Selection task 258 involves ranking the idea among ideas created by other teammates, and selecting a best one of those ideas. Finally, the Submission task 260 involves submitting the selected idea to a jury for evaluation among ideas submitted by other teams.

Preferably, a time restriction is imposed on the ideation process. For example, a global time restriction can be imposed, requiring all participants or users (of one or more teams) to complete the entire ideation process within a certain time frame. Additionally, time restrictions can be imposed for each individual task. For example, a certain amount of time can be imposed for completing the Creation task, the Enrichment task, etc. In so doing, collaborators can be encouraged to submit their ideas quickly and efficiently. Moreover, the use of the platform by many different collaborators and many different teams can be synchronized.

As can be appreciated, tasks may require actions to be carried out by several different users. In other words, several collaborators can work concurrently, each by operating their own processing device 250, 250′, 250″. The collaborators are said to work concurrently in that they can operate their processor-based devices at any time during the time allotted for a task, to complete the tasks at their own pace. Similarly, each team of collaborators are said to work concurrently, in that each team has the freedom to carry out their actions at any time during the time allotted for a task.

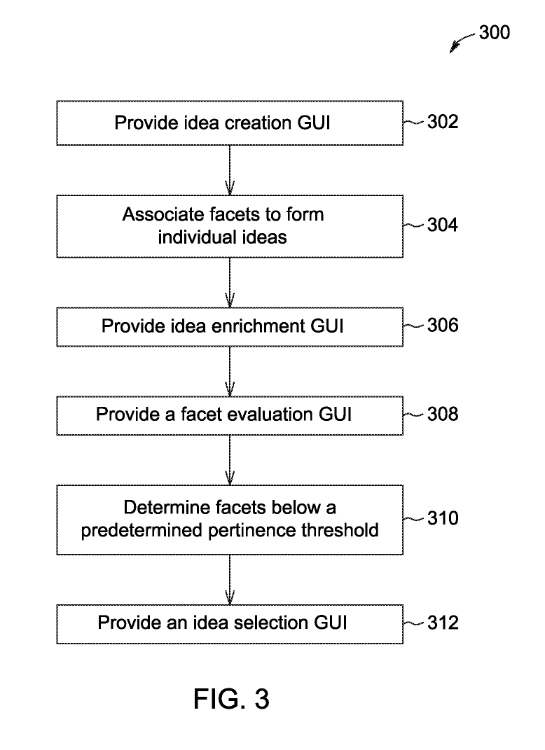

The ideation process will be explained in more detail below with the help of exemplary user interfaces, and with reference to the process 300 illustrated in FIG. 3. For the purposes of the present example, the full ideation process will be illustrated from the perspective of a team having three collaborators: User 1, User 2, and User 3. As can be appreciated, the process can work in a similar manner with more or fewer users. The method and platform also allows to have multiple teams developing ideas concurrently. Moreover, although not illustrated, it should be understood that the same process can be carried out concurrently by other teams comprised of other collaborators.

As part of the Creation task, the platform provides an idea creation GUI (step 302 of FIG. 3) on the display screens of the processor-based devices in a team, allowing collaborators to individually describe their ideas. Separate idea creation GUIs can be provided on each of the processor-based devices, allowing each of the collaborators in a team to work independently. In this configuration, collaborators can create their ideas simultaneously with other collaborators in their team. For example, a User 1 can use their processor-based device to create a first independent idea, while User 2 uses their processor-based device to create a second independent idea. Preferably, during the Creation step, the idea creation GUI only allows collaborators to see the ideas that they themselves are working on, without showing the ideas currently being created by others. It is understood, however, that in some embodiments, the idea creation GUI can be configured to provide special privileges to some users. For example, a team leader or an administrator/animator may be provided with an interface which updates in real time to show ideas currently being worked on by other collaborators.

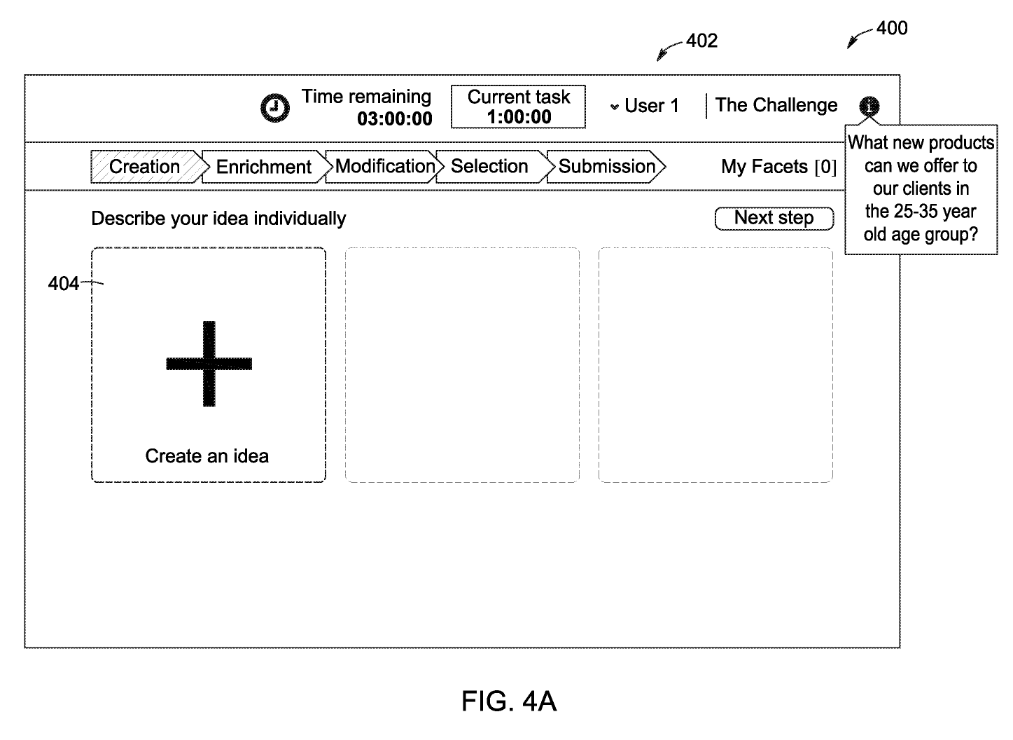

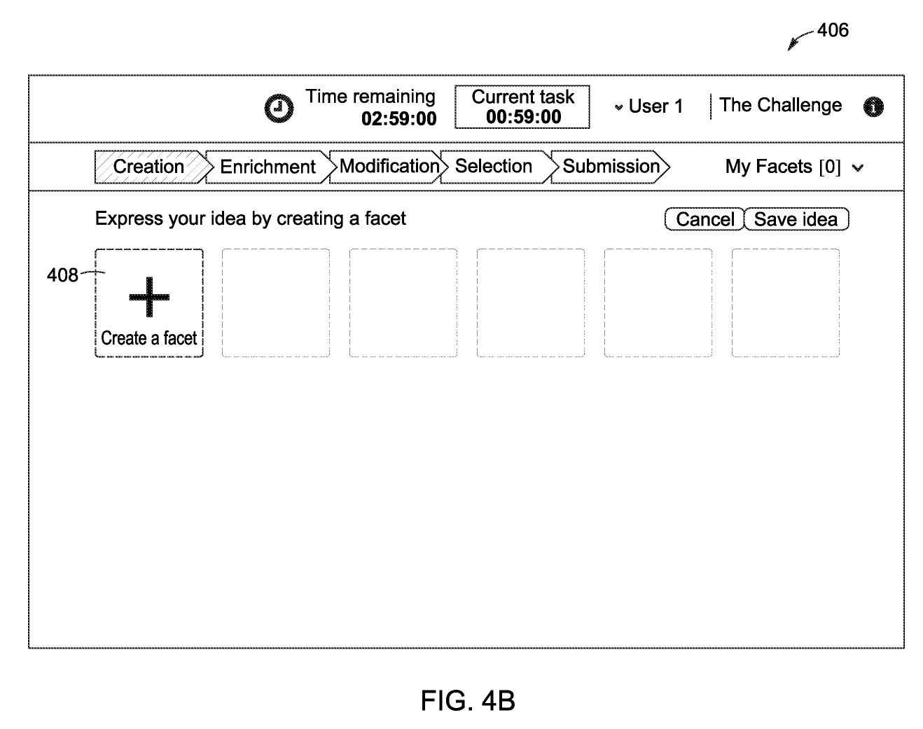

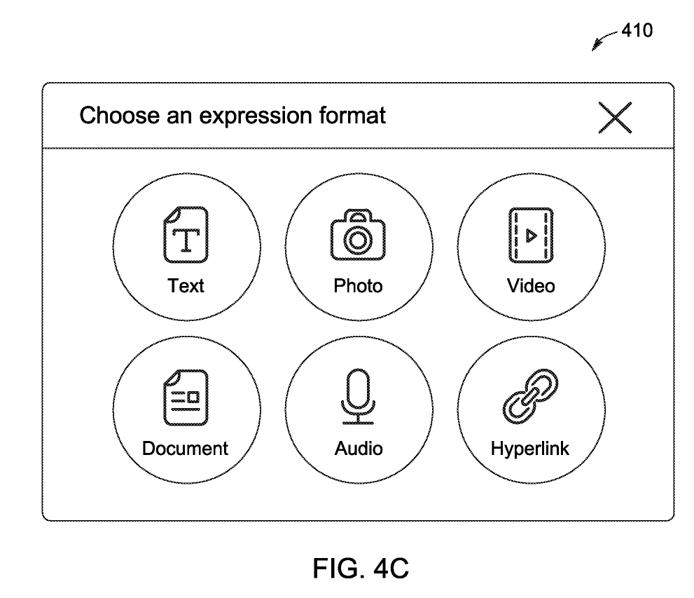

With reference to FIGS. 4A to 4C, several screens of an idea creation GUI 400 are shown according to an embodiment. In the present example, an idea creation GUI 400 shown on the device of User 1 is shown, but it is appreciated that similar idea creation GUIs 400 can be shown on the devices of User 2 and User 3 as well. On an idea creation screen 402, the user is asked to individually describe their idea. A button 404 is provided allowing the user to create a new idea. When creating a new idea, the user can be prompted to provide a name, brief description and/or keywords. This information can aid in summarizing the idea, and can also help in searching for the idea among many different ideas. When an idea is created, the user is led to a facet creation screen 406 which asks the user to express their idea through the creation of facets. A facet creation button 408 allows the user to create a facet, and leads to an expression format selection screen 410 where the user can select an expression format for the facet. In the present embodiment, each facet represents a digital file in one of a plurality of expression formats including text, photos, videos, documents, audio and hyperlinks. Each of these expression formats is represented on the screen, and the user may select which expression format to use for submitting the description.

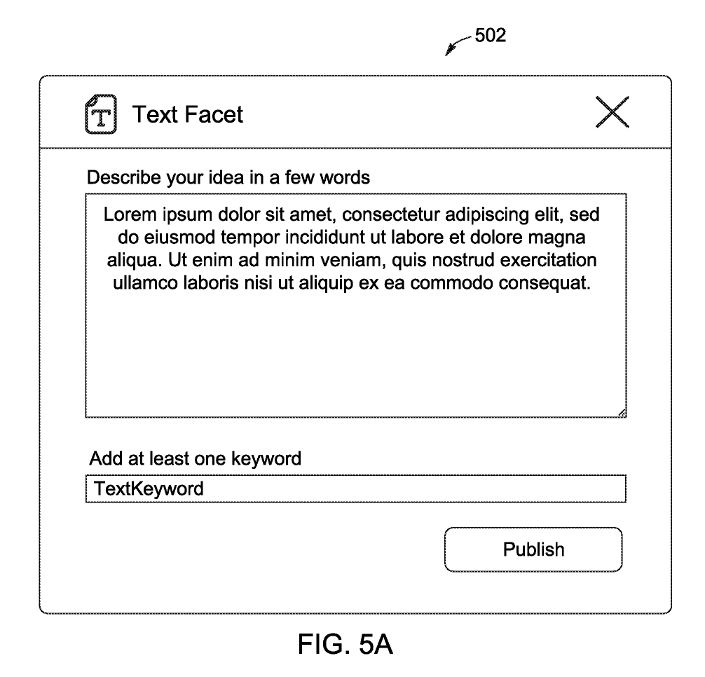

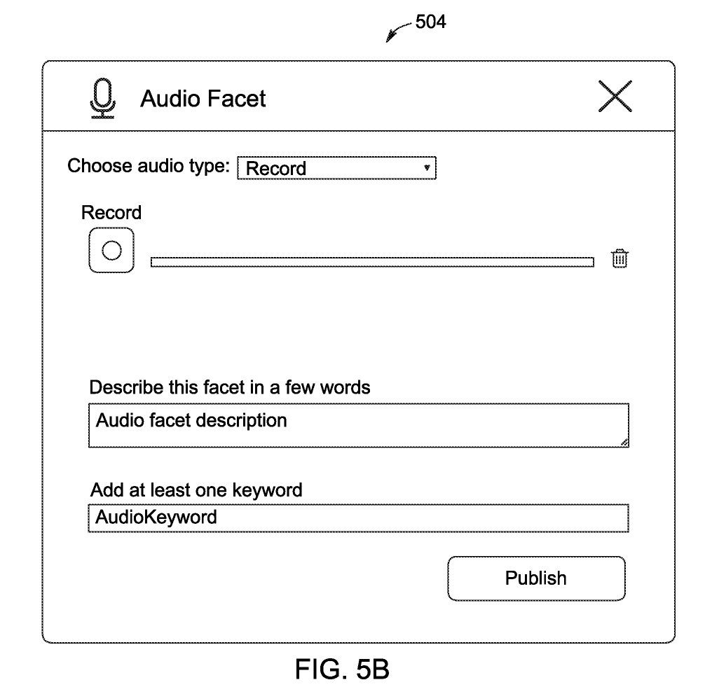

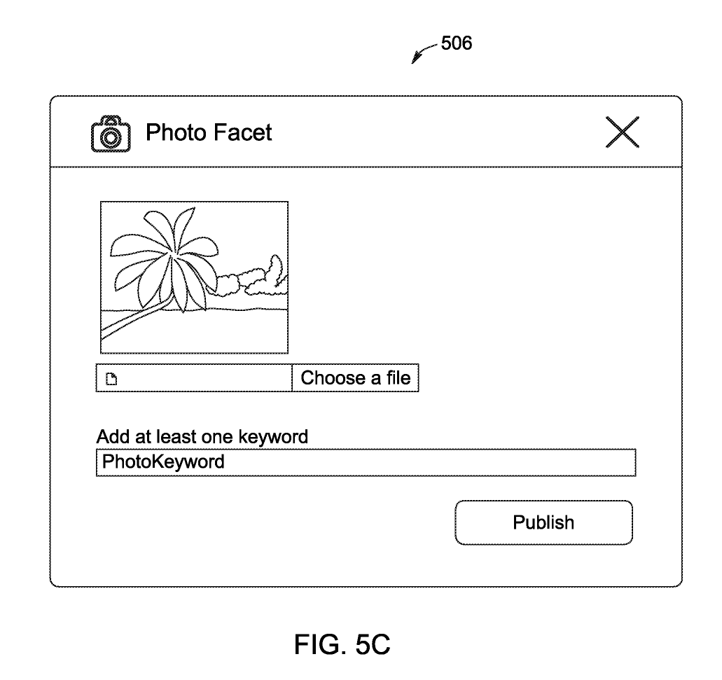

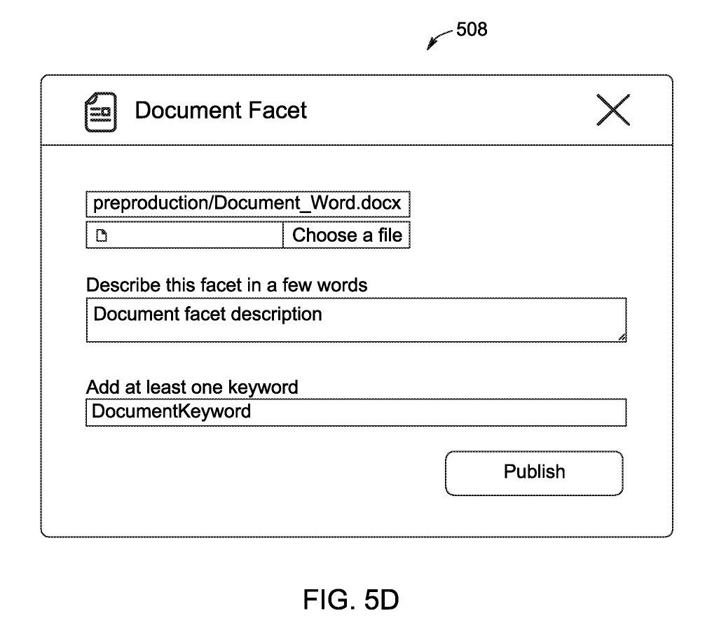

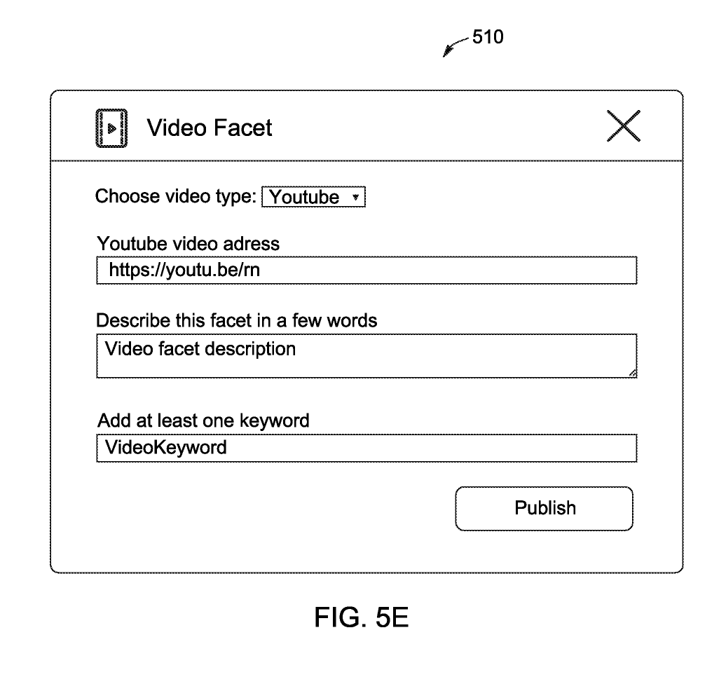

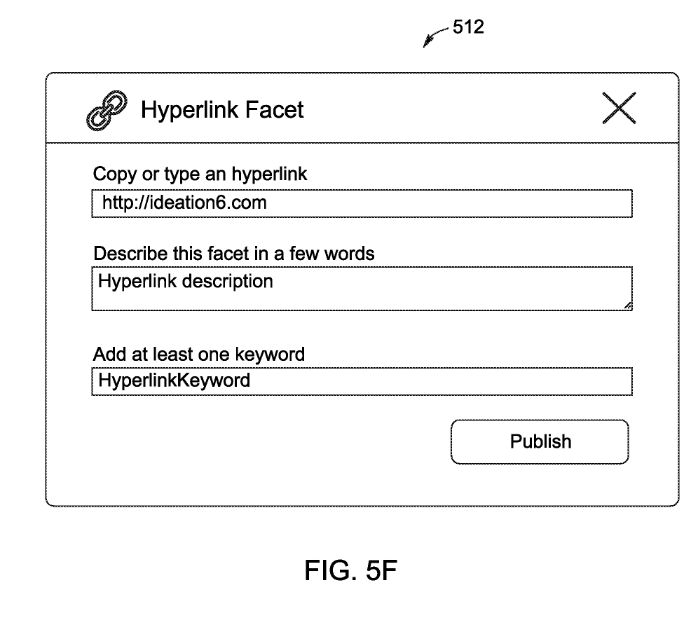

As can be appreciated, each of the expression formats comprises digital files or data. When the user selects an expression format, graphical elements are presented allowing the user to input data to define the facet. FIGS. 5A to 5F are exemplary illustrations of graphical elements that may be presented to the user for entry of data, should the corresponding expression format be selected. In the case of a text facet, the user can be presented with graphical elements 502 allowing the user to enter text to describe their idea. In the case of an audio facet, the user can be presented with graphical elements 504 allowing the user to upload an audio file (such as an MP3, WAV, etc.), or create a recording. In the case of a photo facet, the user can be presented with graphical elements 506 allowing the user to upload an image file (such as a JPEG, GIF, PNG, etc.). In the case of a document facet, the user can be presented with graphical elements 508 allowing the user to upload a document (such as a DOC, XLS, PDF, etc.). In the case of a video facet, the user can be presented with graphical elements 510 allowing the user to upload a video file (such as MP4, WMA, etc.) or provide a URL to embed an online video (such as YouTube, Vimeo, etc.). Finally, in the case of a hyperlink facet, the user can be presented with graphical elements 512 allowing the user to input a hyperlink to an online or network resource, for example.

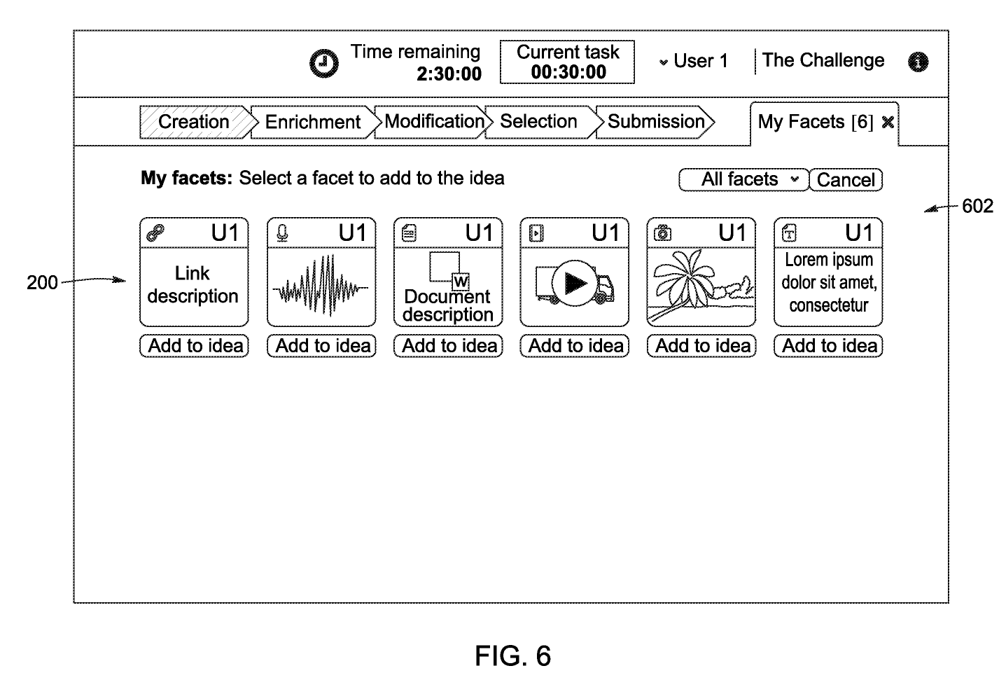

In each case, the graphical elements 502, 504, 506, 508, 510, 512 can include an input allowing the user to provide a descriptive summary of the facet and/or an input allowing the user to associate keywords to the facet. The descriptive summary and keywords can, for example, be used to search help search through the facets and/or to create a visual summary of the facet (as will be described later in more detail). Once the user has inputted the necessary data, the graphical elements 502, 504, 506, 508, 510, 512 can allow the user to publish the facet to their idea immediately, or save the facet for later use. Preferably, each time a user creates a facet (whether it is published or saved), it is received on a remote server and saved in a database, which can be referred to as a facet database. With reference to FIG. 6, this allows for created facets to be accessible through a facet toolbox 602. From the facet toolbox 602, the user can browse their facets and individually add facets to the idea that they are currently working on, if that facet is not already part of the idea. As can be appreciated, when there are a large number of facets in the facet toolbox 602, the facets can be navigated more easily for example by ordering them or filtering them according to expression format, or by using search keywords. The stored facets are thus available for the current ideation challenge in which users are participating in, but also for future challenges. The stored facets may also be simply searched and accessed at a later time by users and/or administrators of the platform.

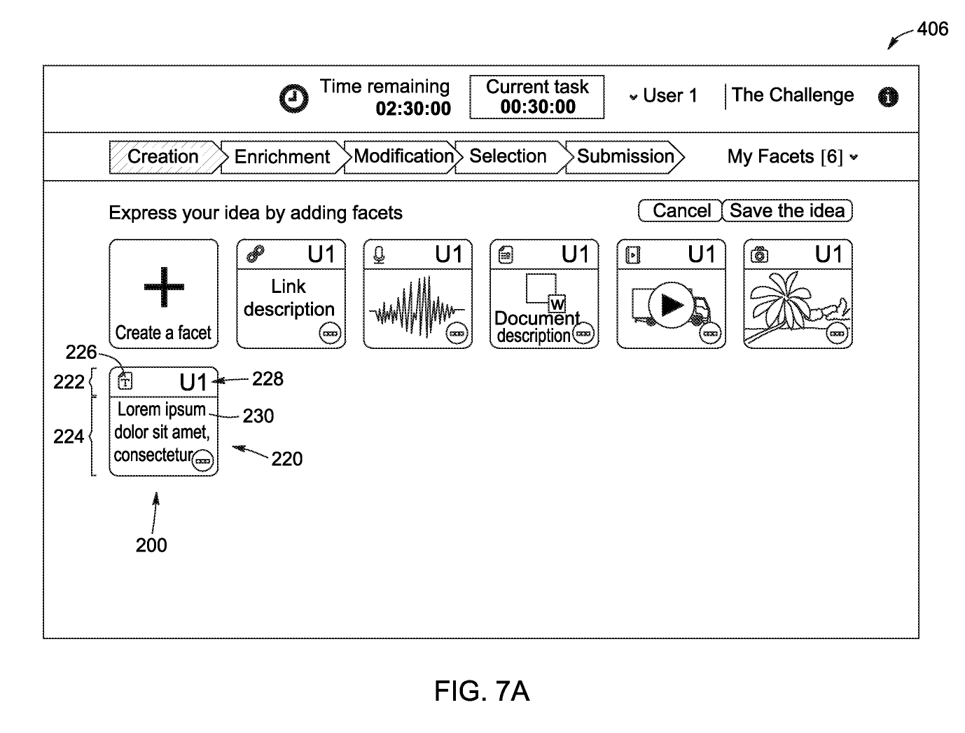

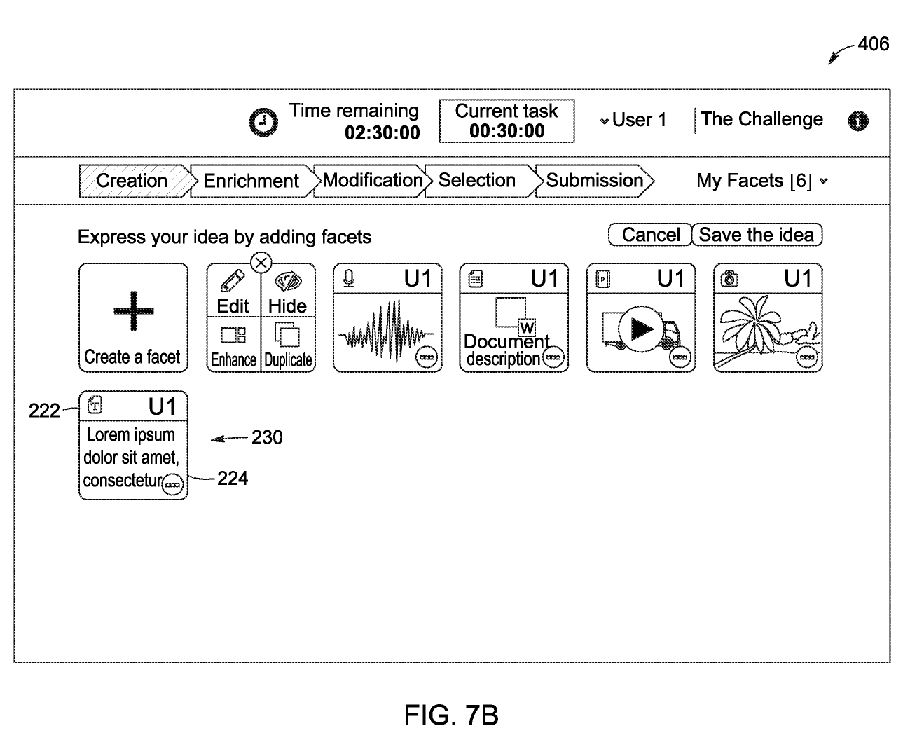

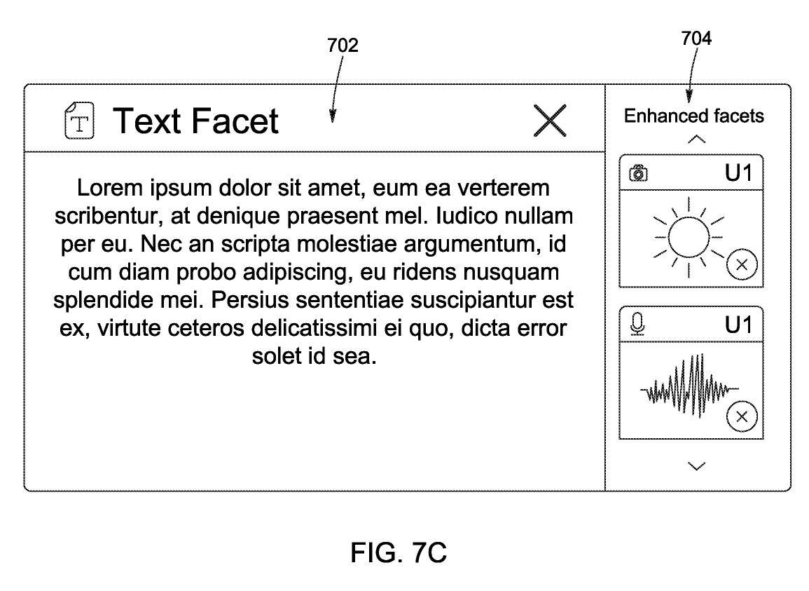

With reference now to FIG. 7A, as the user adds facets to their idea, a visual summary 220 of each of the facets is displayed. Preferably, the visual summary allows the user to understand the content of a facet at a glance. In the present embodiment, the visual summary 220 is in the form of a tile, but other types of icons could be used instead. The tile includes an indication of the type of expression format. In the illustrated embodiment, the type indication comprises an icon 226 in a header portion 222 of the tile, but other indications are also possible. For example, facets can be color-coded according to their expression format, and the header 222 portion can be colored accordingly. In the present embodiment, the header 222 further includes initials 228, providing an indication of which user created the facet. A body portion 224 of the tile can include a content summary 230, visually summarizing the contents of the facet. Preferably, the content summary 230 displays an identifiable portion of the contents of the facet. For example in the case of a photo facet, the content summary 260 can comprise a portion of the photo, or a scaled version of the photo. Similarly, the content summary 230 of a video facet can comprise a still image of a frame of the video. In the case of a text facet, the content summary 230 can comprise an excerpt of the text. In the case of an audio facet, the content summary 230 can comprise a visual waveform of the audio. Additionally or alternatively, the visual summary can include summary text and/or keywords as described above. Preferably, the visual summary 220 can allow the user to consult the full contents of the facets. For example, in the present embodiment, if the user clicks on the header 222 or body 224 portions, an overlay is presented which displays the full contents of the facet. The facet contents can be displayed in many different ways according to the expression format. For example, in the case of a photo facet, the overlay can display the photo; in the case of a document facet, the overlay can display the full description of the document and a link to download the document and/or preview pages of the document can be rendered; in the case of a hyperlink facet, a link can be provided which the user can click to access the contents of the hyperlink; in the case of a video or audio facet, a player can be provided in the overlay to allow the user to play the audio or video; etc.

As shown in FIG. 7B, the facet creation screen 406 can further allow users to edit, hide, duplicate and/or enhance existing facets. As can be appreciated, these functions can also be made available for facets which are not part of an idea, for example in the facet toolbox of FIG. 6. In embodiment illustrated in FIG. 7B, these functions are accessible by clicking on a menu button in a lower corner of the body portion 224 of the visual summary 230 of a facet. The edit function allows the user to modify the contents of the facet, for example using the same graphical elements shown in FIGS. 5A to 5F. The hide function allows the user to remove a facet from their idea. In the present embodiment, a removed facet is still retained in the facet toolbox of FIG. 6, and can thus be added again by the user. In other embodiments, however, removing a facet can delete it altogether. The duplicate function allows the user to create a copy of the facet, thereby creating a new facet with the same data as the original which can be modified independently. Finally, the enhance function allows the user to nest sub-facets into a selected facet. When a facet is enhanced, it can be referred to as a parent facet. When enhancing a parent facet, the user can be prompted to add children to the parent facet by creating new facets or selecting existing facets from their facet toolbox. The child facets can, for example, serve to better express the idea of the parent facet, and their expression format can differ from that of the parent facet. As can be appreciated, a visual summary 230 of an enhanced facet can contain a visual indication to this effect, for example in the form of an icon in the header portion 222 of the tile. As illustrated in FIG. 7C, when a user clicks the tile to view its contents, the contents of the parent facet can be displayed in a main window 702, while also showing visual summaries of the child facets adjacent thereto 704. The user can then click the visual summaries of the child facets in order to view their contents. In the present embodiment, nested facets are limited to a depth of one level (i.e. child facets cannot themselves have children). In other embodiments, however, nested facets can continue to further levels.

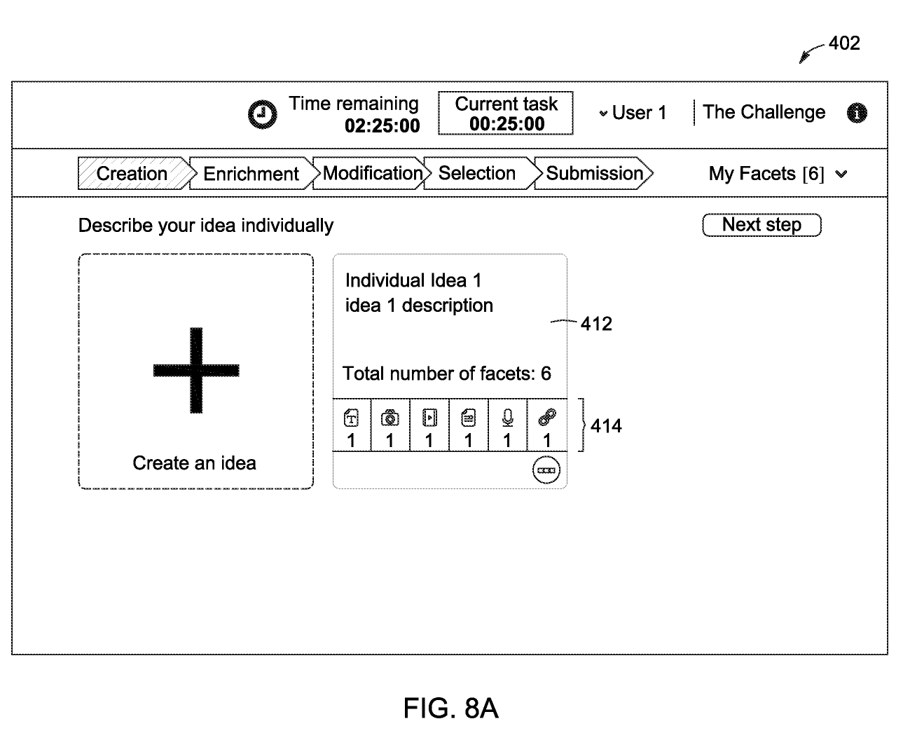

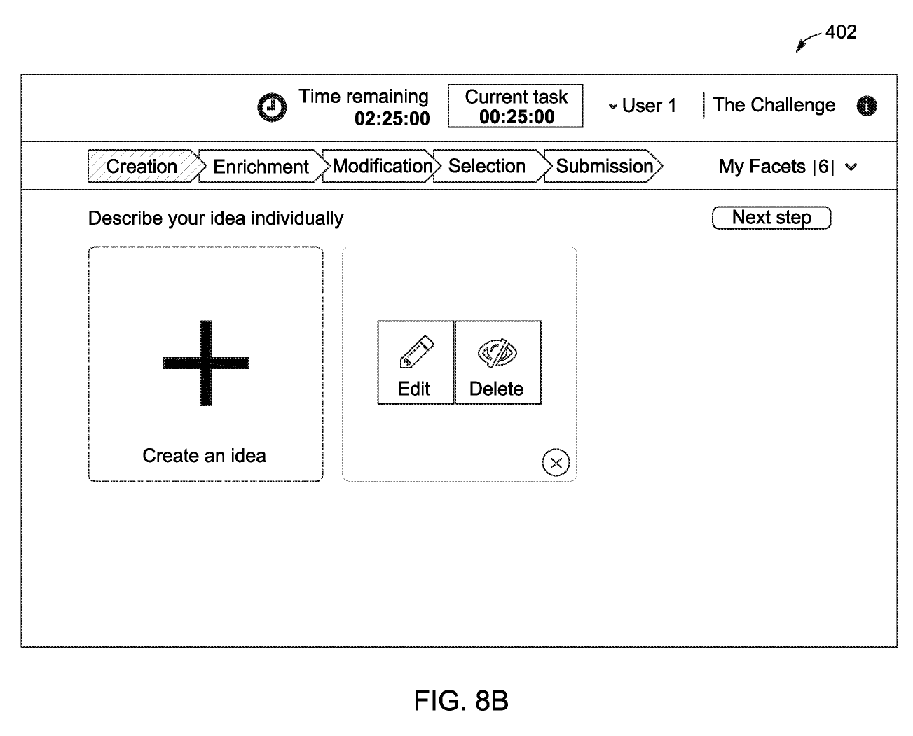

Once a user has expressed their idea using various facets, the user can save their idea. When saving their idea, the facets which the user has selected to form part of their idea are associated in order to form an individual idea (step 304 of FIG. 3). With reference to FIG. 8A, when an individual idea has been saved, a visual summary 412 of the individual idea is displayed on the idea creation screen 402. In the present embodiment, the visual summary 412 is in the form of a tile, and displays the idea title, description, the total number of facets, and a facet summary 414. In the facet summary 414, facets of the same expression format are grouped together. The grouping of expression formats shows the total number of facets per expression format used to express the idea. The user can, for example, click on the grouping to view visual summaries of each of the facets in the group. As can be appreciated, in other embodiments, other information relating to the individual idea can be displayed as well, including information about the user who created the idea, an identification number, tag lines or keywords associated with the idea. More detailed information about the user who created the idea can be provided, such as pictures, job titles, company history etc. As can be further appreciated, in other embodiments, the visual summary 412 of the idea and/or the facet summary 414 can be displayed in different forms. For example, the individual idea can be displayed in the form of a geometric object, as will be described hereinafter, or the facet summary 414 can include visual summaries of the individual facets in a group instead of, or in addition to, showing the total number of facets in the group.

In the present example, the user has only created one individual idea. However, it is appreciated that in other cases, the user can create multiple individual ideas which will also eventually be displayed on the idea creation screen 402, shown in FIG. 8B. As shown in FIG. 8B, the user can continue to create more individual ideas, or tweak their existing individual ideas, for example by editing them and returning to the facet creation screen 406, or by deleting their ideas altogether. This can continue until the time allotted for the Creation task has expired, or if the team leader forces the team to move to the next task.

Once the team completes the Creation task, the platform will then move on to the Enrichment task. As part of the Enrichment task, the platform first provides an idea enrichment GUI on the display screens of the processor-based devices, displaying the individual ideas created by a team one at a time, and allowing the collaborators in the team to add or modify facets of those individual ideas to form enriched ideas (step 306 of FIG. 3). In some embodiments, each of the ideas are displayed one at a time in a random order.

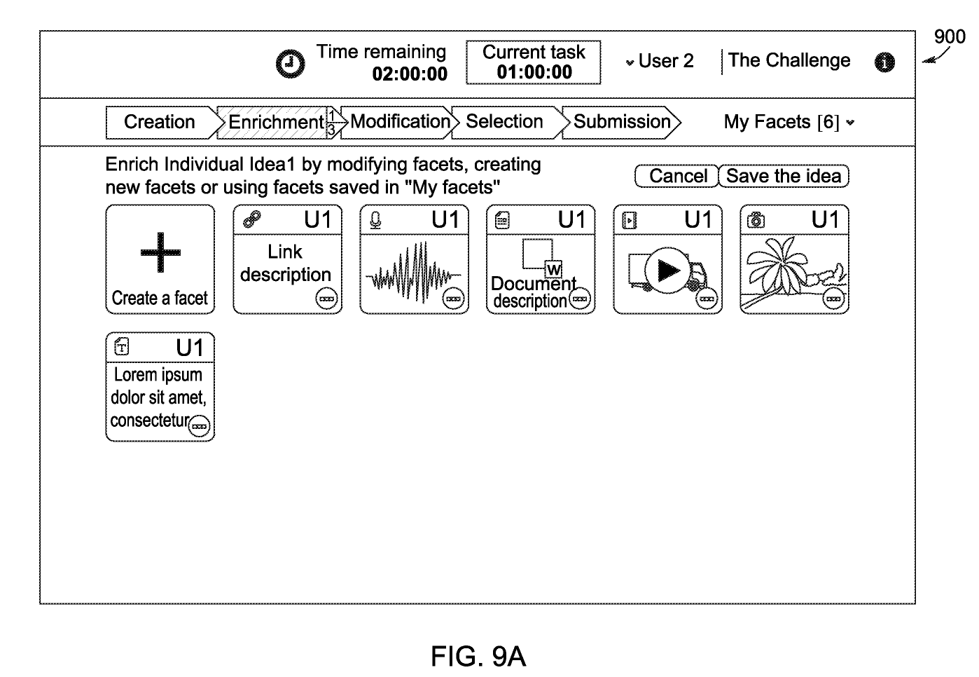

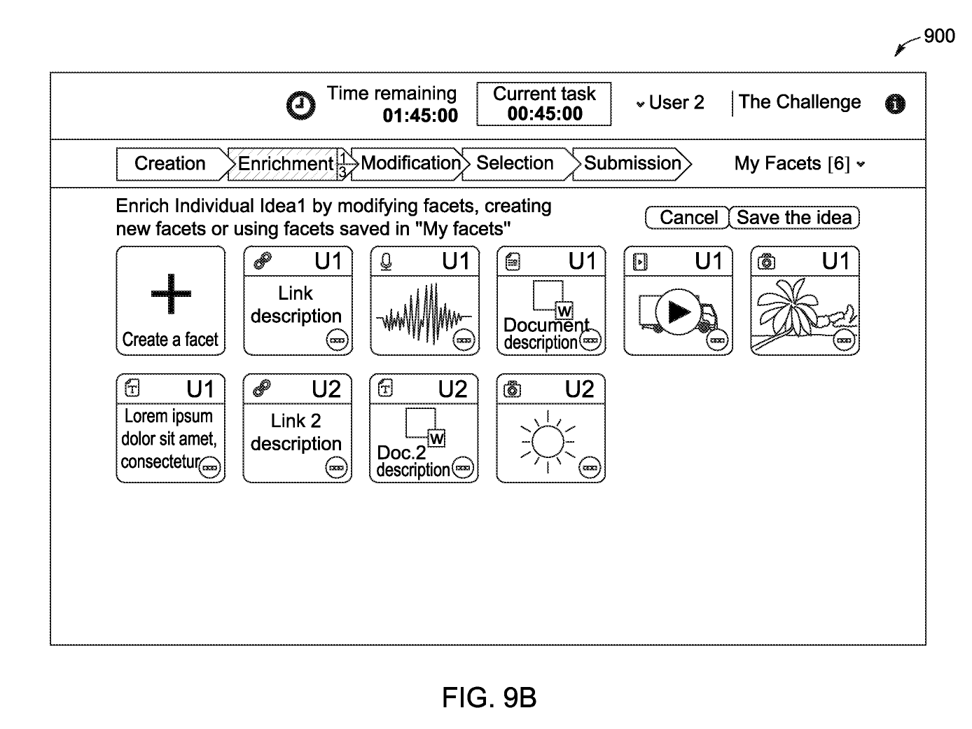

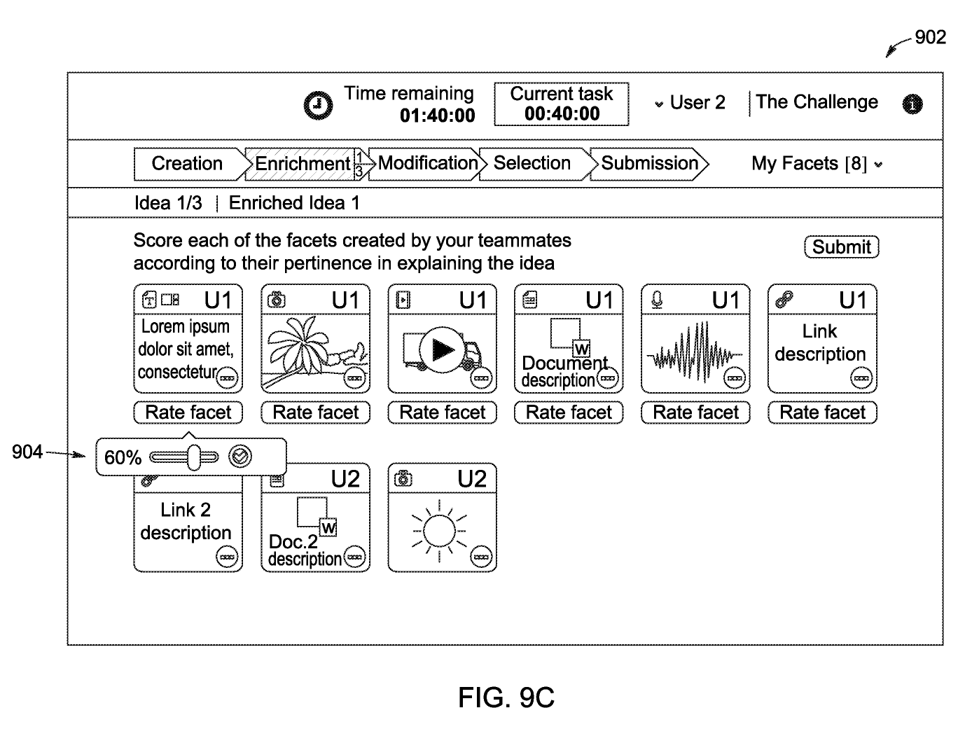

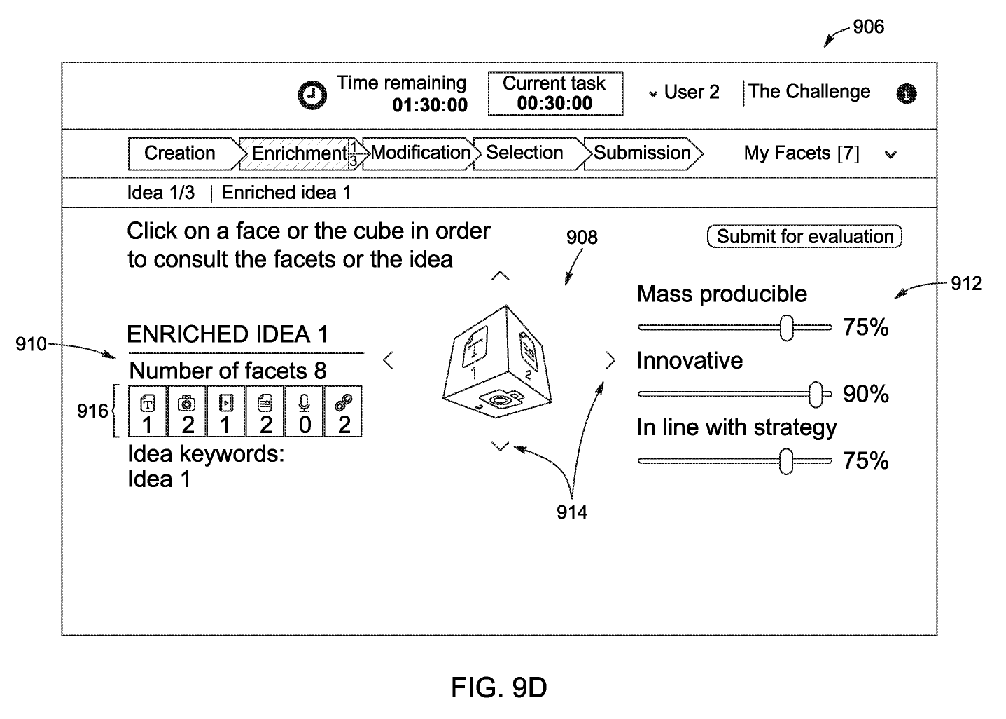

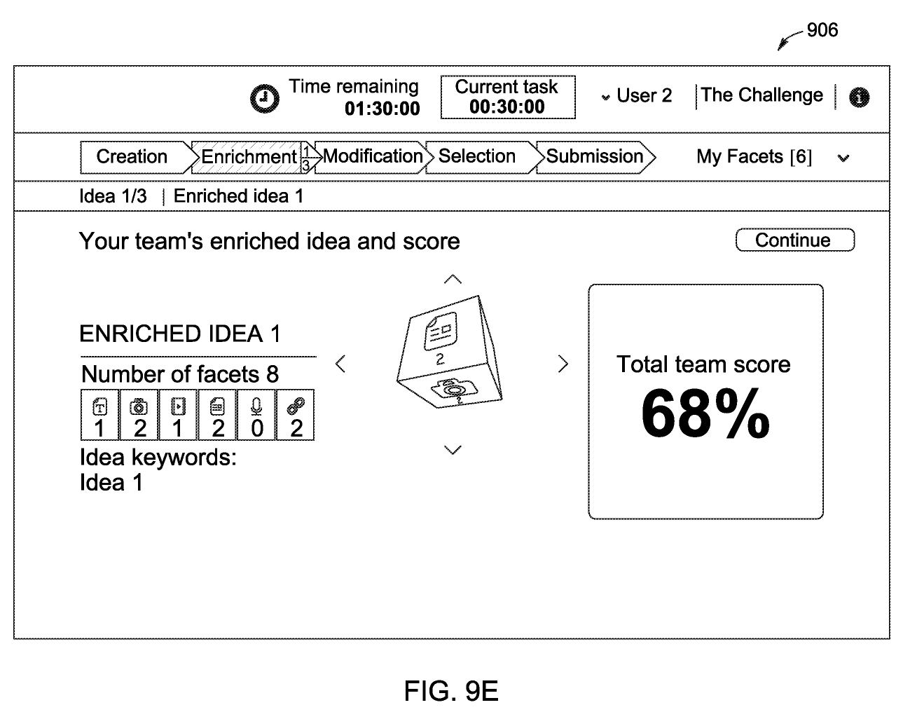

With reference to FIG. 9A, an idea enrichment GUI 900 is shown according to an embodiment. For exemplary purposes, the idea enrichment GUI 900 on the processor-based device of User 2 is shown, but it is appreciated that similar idea enrichment GUIs 900 can be shown on the devices of User 1 and User 3 as well. The illustrated idea enrichment GUI 900 displays the first individual idea created by User 1. The idea enrichment GUI 900 is similar to the facet creation screen 406 of FIGS. 4B and 7A, in that it displays visual summaries of each of the facets composing the idea, and allows the user to edit, hide, enhance and/or duplicate facets and/or add new facets. In the present example, each of the facets created by User 1 are displayed, and identified using the initials “U1”. As shown in FIG. 9B, User 2 can create new facts, add facets already stored in their facet toolbox, or modify facets already in the ideas, (all in a similar manner as described with respect to the idea creation GUI) in order to help better express the idea, or further flesh out the idea. In the present example, User 2 has created three new facets, which are displayed and identified using the initials “U2”. In some embodiments, users can be permitted to edit, hide, enhance and/or duplicate facets which they created, while restricting such operations on facets created by others.

During the Enrichment task, all collaborators in the team preferably work at the same time to enrich the same idea. Therefore, the idea enrichment GUI 900 preferably updates in real time on the devices of each of the collaborators, so that they all view the same information. For example, when the team is working on enriching individual Idea 1, if User 2 adds a new facet to the idea, that new facet will immediately show up on their idea enrichment GUI 900. The new facet will also immediately show up on the idea enrichment GUI 900 of Users 1 and Users 3. Similarly, any changes made by any of the collaborators can be immediately updated on the devices of other collaborators in the team. In this configuration, each collaborator in a team can work independently on their own device to enrich the idea, while being able to view and modify enrichments made by others in real time.

After all the collaborators in the team have finished providing their enhancements, the individual idea can thereafter be referred to as an enriched idea. At this stage, the enriched idea may have a large number of facets, and this may not be the most pertinent way of expressing the idea. Therefore, the Enrichment task next involves providing a facet evaluation GUI on the display screens of the processor-based devices in the team, displaying each of the facets forming the enriched idea and allowing collaborators to vote on a pertinence of each of the facets, to best explain said idea (step 308 of FIG. 3). In some embodiments, collaborators can only vote on facets created by other collaborators.

With reference to FIG. 9C, a facet evaluation GUI 902 is shown according to an embodiment. For exemplary purposes, the facet evaluation GUI 902 on the processor-based device of User 2 is shown, but it is appreciated that similar facet evaluation GUIs 902 can be shown on the devices of User 1 and User 3 as well. The illustrated facet evaluation GUI 902 shows all the facets of the enriched idea created by all members of the team. The user is asked to rate each of the facets according to their pertinence in best explaining the idea. In the present example, the rating can be provided by way of a slider element 904, allowing a user to assign a numerical rating, in the form of a percentage. The user can continue to assign a numerical rating to each individual facet of the idea. Preferably, the user is only permitted to rate facets created or modified by other collaborators in the team. For example, in the present example, User 2 can only vote on facets created by User 1 (denoted with the initials “U1”). User 2 is not given the option of voting on the facets they created (denoted with initials “U2”).

As can be appreciated, during the time allotted for the Enrichment task, each of the collaborators can provide their respective ratings for each of the facets of the enriched idea. The ratings from each of the collaborators are received at a server, and are combined in order to calculate an average pertinence rating for each facet. This average pertinence rating can then be used to determine facets which are below a predetermined pertinence threshold, for example below 50%. In the present example, in order to more pertinently express the idea, these less pertinent facets are omitted when displaying the idea during the subsequent tasks of the ideation process (step 310 of FIG. 3).

After all the collaborators in the team have finished providing their ratings, the Enrichment task can next involve providing an idea evaluation GUI on the display screens of the processor-based devices in the team. This GUI can display the enriched ideas one at a time, and allow each of the collaborators in the team to numerically vote on predetermined qualities of each of the enriched ideas as a whole.

With reference to FIG. 9D, an idea evaluation GUI 906 is shown according to an embodiment. For exemplary purposes, the idea evaluation GUI 906 on the processor-based device of User 2 is shown, but it is appreciated that similar idea evaluation GUIs 906 can be shown on the devices of User 1 and User 3 as well. In the present embodiment, the idea evaluation GUI 906 includes the enriched idea 908 displayed alongside a visual summary 910 of the enriched idea, and interface elements 912 for voting on predetermined qualities of the enriched idea. In the present example, the audio facet was determined to be below a pertinence threshold, and has thus been omitted in displaying the idea.

In the present embodiment, the enriched idea 908 is displayed by synthesising it into a geometric shape. In order to synthesize the geometric shape, the facets forming the enriched idea are grouped together according to their expression format. A geometric shape can then be generated, with different sections of the shape comprising one group of facets of the same expression format. As can be appreciated, in the present embodiment, six different expression types are provided. The idea can thus be synthesized into a 3D cube, with each face of the cube corresponding to an expression format. In the present embodiment, the cube represents the idea by providing on each face an indication of the expression format type and the total number of facets of that expression type used in the idea. Preferably, each of the faces is color coded according to the expression format which it represents. In other embodiments, the idea can be represented differently. For example, visual summaries of each of the facets can be provided directly on the cube.

In other embodiments, for example where there are more or fewer expression formats, the geometric shape can be any polyhedron, such as a triangular pyramid, a tetrahedron, an hexahedron, an octahedron, etc. Moreover, in other embodiments, some faces of the geometric shape can contain other information about the idea. For example, summary information about the idea may be provided on one of the faces of the geometric shape. The summary information may comprise information about the one or more individuals who are submitting the idea, the date of submission, the number of facets per each expression format, tag lines or keywords associated with the idea, an identification number for the idea submission, and other such information. In another example, more detailed information about the one or more individuals submitting the idea may be provided, such as pictures, job titles, company history, etc. A summary description of the idea may also be provided on an available face. Other information may also be provided.

Preferably, the geometric shape can be manipulated, allowing the user to explore the idea. In the present embodiment, controls 914 are provided, allowing the user to rotate the cube and view different faces. It is appreciated that the user can also rotate the cube by dragging it using a cursor, and that the cube can be rotated automatically without direct interaction by the user. The user can further “unfold” the cube by selecting one of the faces. When a face is selected, for example by taping or clicking it, the GUI 906 can display visual summaries of each of the facets part of that face. The user can then proceed to interact with the visual summaries in order to view the content of each individual facet. The GUI may further allow the user to manipulate the idea in different ways, including a zooming, and a displacement of the cube. The faces of the cube may also be decomposed into individual facets to allow the user to visualize the facets hidden underneath the top facets of each face. Audio or video files may be played, attached documents may be opened, and hyperlinks may be followed by interacting with them directly on the face of the cube.

In the illustrated embodiment, the visual summary 910 displays summary information of the idea, as described above. In the current example, this summary information includes the name of the idea, and the keywords associated with the idea. However, other summary information can also be displayed. The visual summary 910 further includes a visual indication 916 of the total number of facets of each expression format used to form the idea. In the present embodiment, the visual indication 916 replicates the functionality of the faces of the cube. Several tiles are provided, each representing facets grouped according to expression type. The tiles can display an indication of the expression type which they represent, such as an icon and/or color code, and can include a number indicating the total number of facets of that expression type in the idea. The user can select a tile to consult each of the facets of that expression type.

Finally, the interface elements 912 allow the user to vote on predetermined qualities of the enriched ideas. In the present example, the user is asked to vote on the idea being mass producible, innovative, and in line with strategy of the company. The interface 912 includes sliders, allowing the user to assign numerical values to each of these qualities as a percentage. These ratings are received and combined with ratings received from other collaborators in the team in order to calculate the team's overall rating of the idea, as illustrated in FIG. 9E.

As can be appreciated, the various steps of the Enrichment task are carried out for each of the individual ideas created by collaborators in a team. In the present example, each steps of the enrichment task were shown with respect to Idea 1 created by User 1. The same steps can subsequently be applied to Idea 2 created by User 2, and to Idea 3 created by User 3. In so doing, Idea 2 and Idea 3 will be enriched in the same way, resulting in enriched ideas with an overall rating attributed thereto. In the present embodiment, each of the steps were carried out for one idea before proceeding to a subsequent idea. In other embodiments however, this order can vary. For example, each step of the Enrichment task can be performed for all the ideas before proceeding to the next step. Moreover, the order in which ideas are enhanced can vary. For example, the ideas can be presented to users for enhancement in a random order.

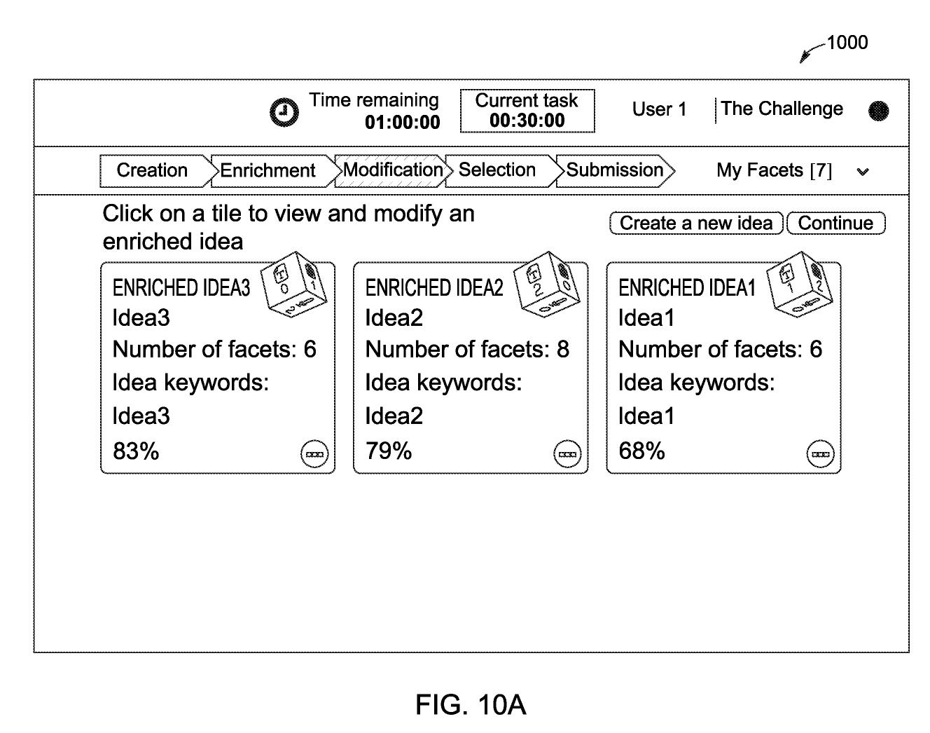

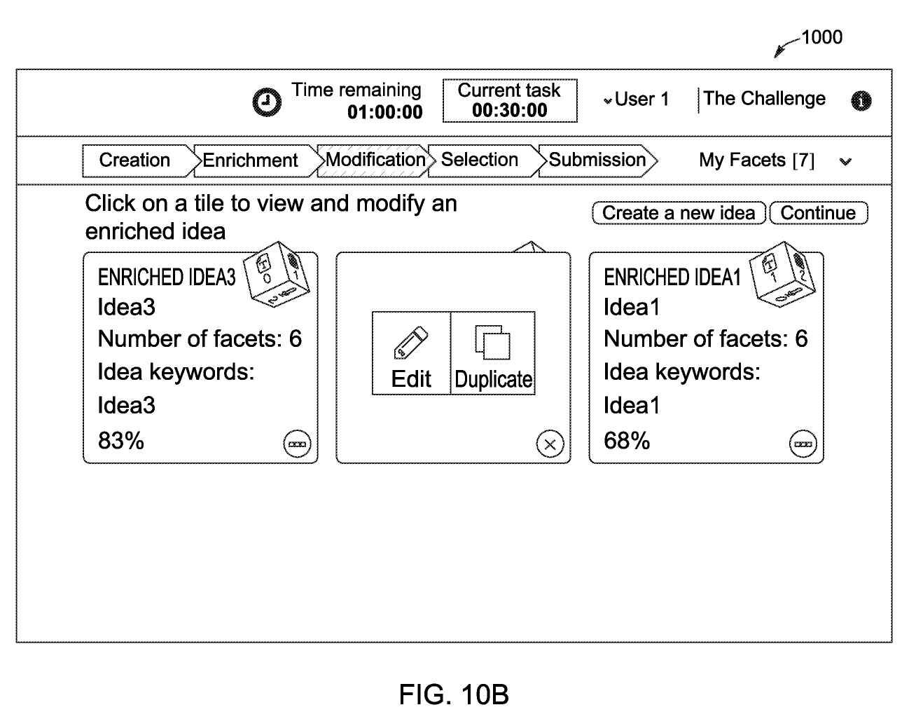

Once the team completes the Enrichment task, the platform will then move on to the Modification task. As part of the Modification task, the platform provides an idea modification GUI on the display screens of the processor-based devices, allowing the enriched ideas to be modified or duplicated. As shown in FIGS. 10A and 10B, the idea modification GUI 1000 displays each of the enriched ideas, preferably ranked according to their overall rating. The GUI 1000 allows the user to edit the idea, for example returning to the facet creation screen for that idea, and allowing facets to be added, edited, hidden, enriched and/or duplicated. The GUI 1000 further allows for new ideas to be created from scratch. In some embodiments, whenever an idea is modified or a new idea is created, the platform repeats the steps of the Enrichment task, giving collaborators the opportunity to enrich and vote on the new or modified idea. The GUI 1000 further allows users to duplicate ideas, thus creating a copy which can be edited independent of the original.

Preferably, the Modification task is performed only by a team leader. Therefore, although the GUI 1000 can be displayed on the devices of each of the collaborators of the team, these devices will be in a read-only mode. The collaborators can discuss in a group, and the team leader can carry out the Modification task on their device. Preferably, the displays of each of the devices are updated in real time, such that as the ideas are modified, the changes are reflected on the displays of each of the collaborators in the team. Preferably still, the displays of the collaborators mirror the display of the team leader, such that the collaborators can follow along as the team leader navigates through ideas and facets to make modifications.

Once the team leader is satisfied with the modifications, the platform can then move to the Selection task. As part of this task, an idea selection GUI is provided on the display screen of at least one of the processor-based devices in each team. The idea selection GUI allows the collaborators in each team to select at least one final idea from the enriched individual ideas created by their team (step 312 of FIG. 3).

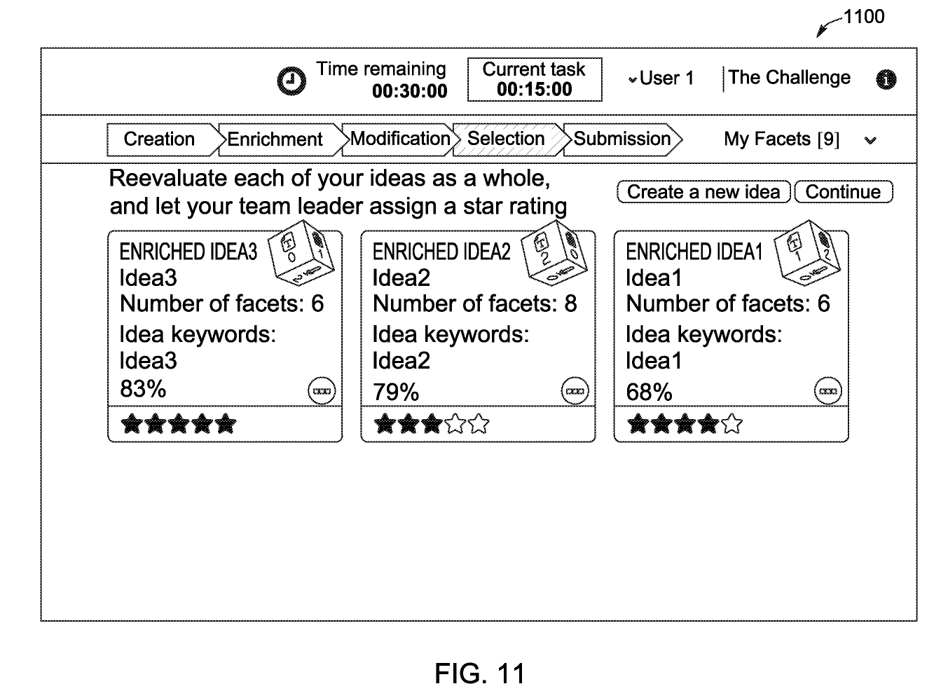

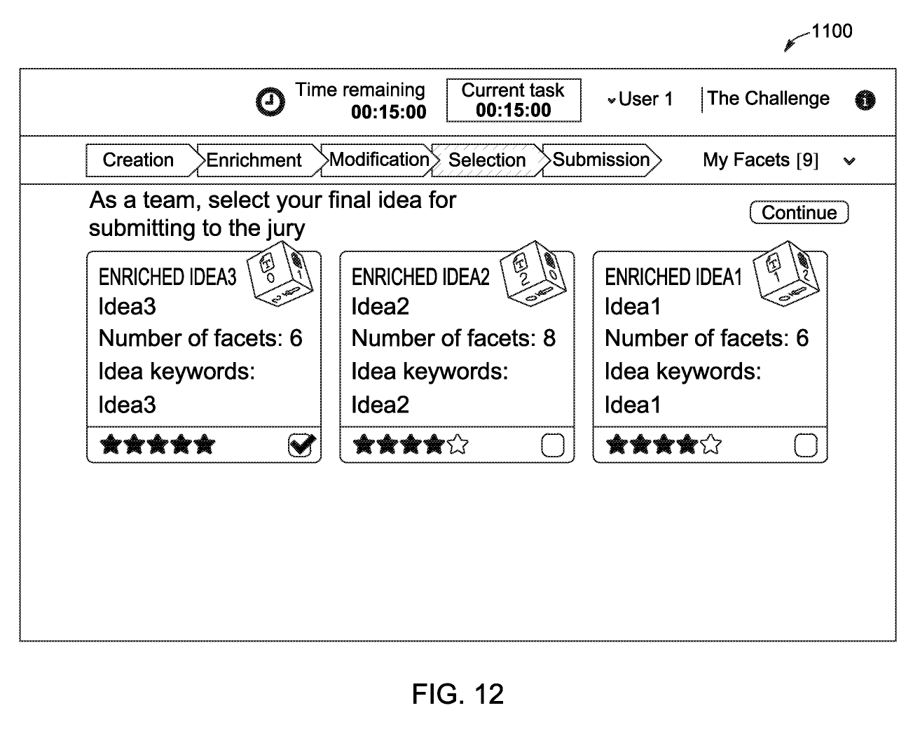

To facilitate the selection process, the platform can allow teams to re-rank their ideas by considering them as a whole. As shown in FIG. 11, the idea selection GUI 1100 can allow the user to assign a star rating to each of the ideas. This evaluation can be considered as holistic, as it does not involve rating specific qualities or features of the idea, but rather the idea overall. This rating can be received and, as shown in FIG. 12, the GUI 1100 can re-rank the ideas according to their star rating. Finally, one or more of the ideas can be selected as the team's final idea, and thus the final product of their ideation efforts. The final idea or ideas can then be submitted to a jury for evaluation among final ideas submitted by all the other teams.

Preferably, as with the Modification task, the Selection and Submission task are performed by a team leader. The collaborators in the team can discuss as a group in order to collectively direct the leader to rank their ideas and select a final idea. Preferably still, the GUI 1100 on the devices of the collaborators are read-only mirrors of the team leader's GUI, allowing the collaborators in the team to follow along with the ranking and selection.

Preferably, every idea created during the ideation process by any team, whether or not it is selected as a final idea, is stored in an idea database for later use. In some embodiments, stored ideas are provided in a searchable format for future use by managers and/or product/service development teams. Stored ideas may be searchable by keywords, date created, creation user (or team), and other search criteria. In some embodiments, specific keyword tags are associated with the ideas at the time of synthesizing and/or creation. These tags may be stored separately for quick reference when searching for a stored idea. In some embodiments, the ideation platform allows stored ideas to be retrieved and further processed.

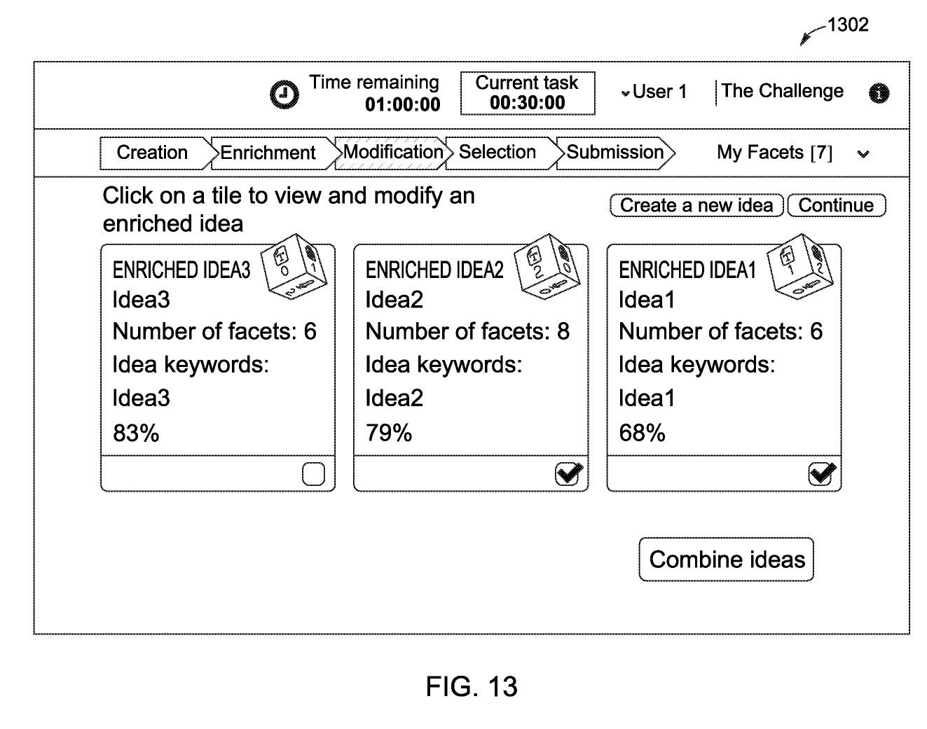

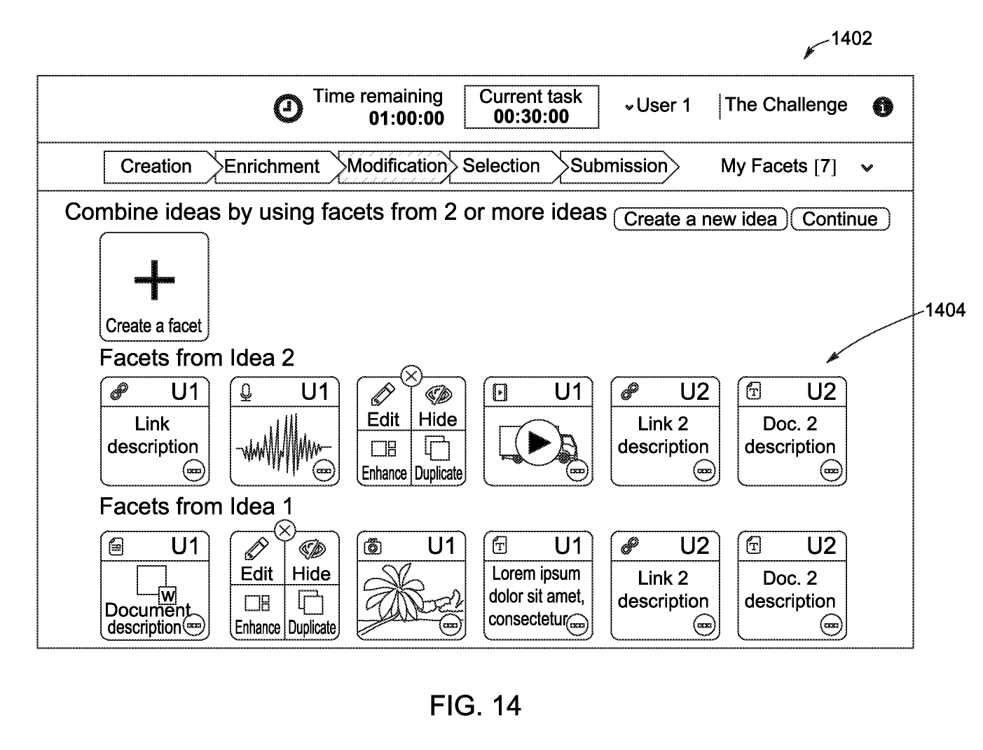

Moreover, in some embodiments, the ideation platform can comprise a combination workspace, where ideas may be combined to create new ideas. FIG. 13 illustrates an exemplary screenshot 1302 of a combination workspace, in the form of a page in an idea modification GUI. As per the view in FIG. 13, two or more ideas may be selected for combination. Selected ideas are then displayed together, as per the exemplary screenshot 1402 of FIG. 14, where each of the facets of those ideas is shown. A new idea space 1404 allows for the user to select the facets for inclusion in the new combined idea. For example, the facets can be edited, hidden, enhanced and/or duplicated. Moreover, new facets can also be created. In some embodiments, facets can be selected for inclusion, for example, using a drag and drop function or a double-click function to manipulate the facets. Selected facets may be modified before or after having been provided in the new idea space 1404. The finalized facets in the new idea space 1404 may be synthesized into a geometric shape representing the new idea. In the present embodiment, the combination workspace is provided as part of the Modification task. As such, when a new combined idea is created by a team leader, it can go back through the enhancement task, allowing others in the team to further enhance the idea and vote on its pertinence. In other embodiments, however, this workspace can be provided to animators or company managers, who can view ideas stored from previous competitions, and themselves combine ideas to create new ones. The ideation platform may allow other actions to be performed using the stored ideas, such as modifying stored ideas, creating a new idea from a stored idea, and creating completely new ideas. In some embodiments, some or all of the features available in the GUI of collaborators participating in the ideation process can also be available for stored ideas.

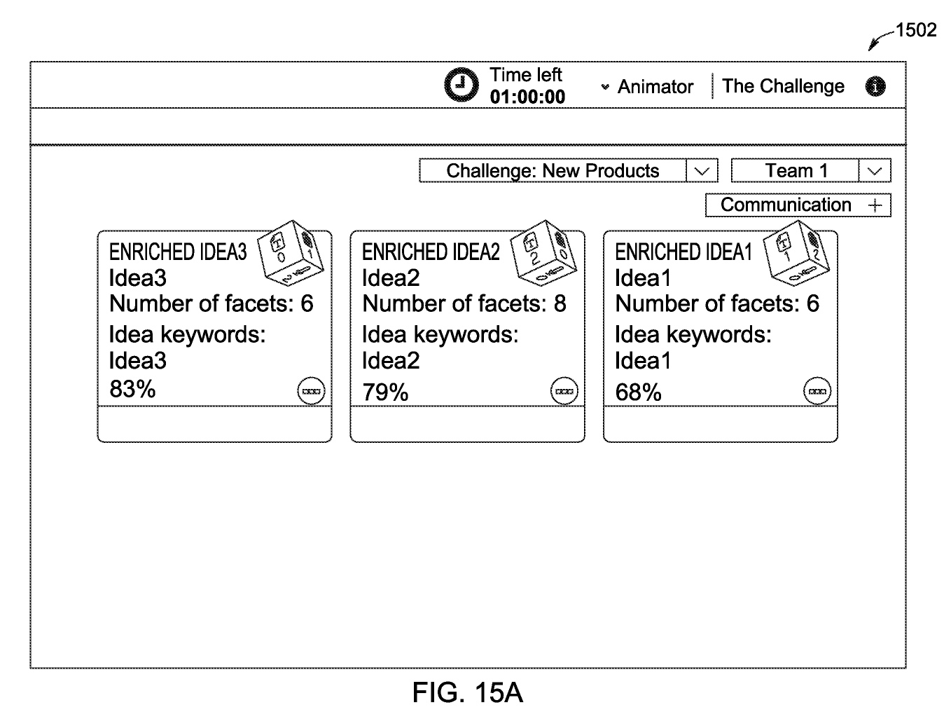

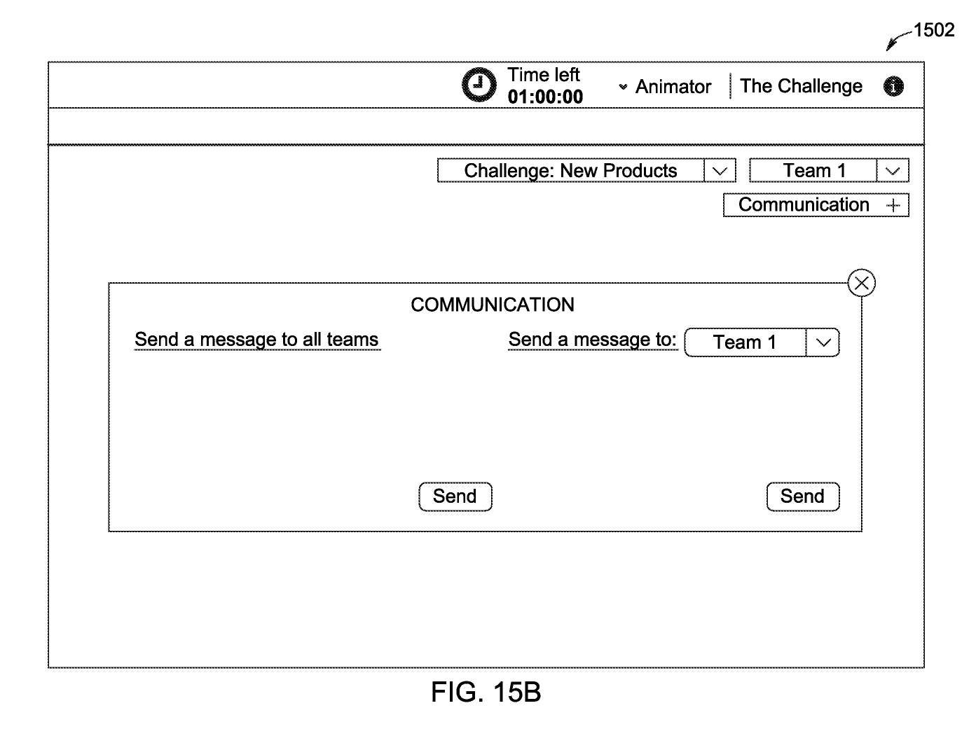

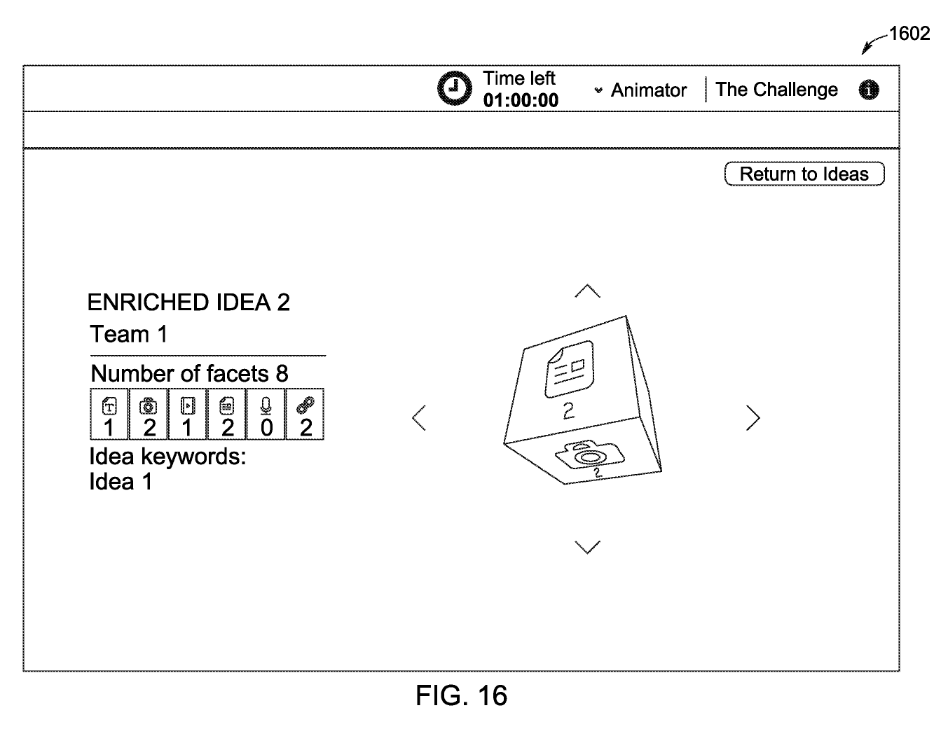

In some embodiments, the ideation platform may be configured to allow an animator (i.e. a person charged with running the ideation process among many teams, and helping the process run smoothly), company manager, or other higher access-rights user to view the progress of individuals and/or teams as the ideas are being generated. FIGS. 15A and 15B illustrate an example screenshots of a high-level view of an animator GUI (it is appreciated that other similar interfaces can be provided to company managers or other users who require a high-level access during or after the ideation process). In FIG. 15A, the animator can select a challenge, and a team participating in that challenge. Upon selecting a team, the GUI 1502 can show the ideas generated by that team at a current point in the ideation process. As shown in the screenshot 1602 of FIG. 16, the animator can select any of those ideas to explore its contents. In some embodiments, the animator GUI can include a more detailed view of one team's ideation process, showing the facets as they are being created and manipulated by the team members. The higher access-rights user may be allowed to intervene in an ideation process of a team, to provide input and/or insight or to help guide the team in the right direction. For example, as illustrated in FIG. 15B, the animator can send a message to all or a selected one of the teams participating in the ideation process. The interaction of each user with the ideation platform may be recorded and stored, for later access. This may provide additional insight on how the idea came about and who contributed to it in what way.

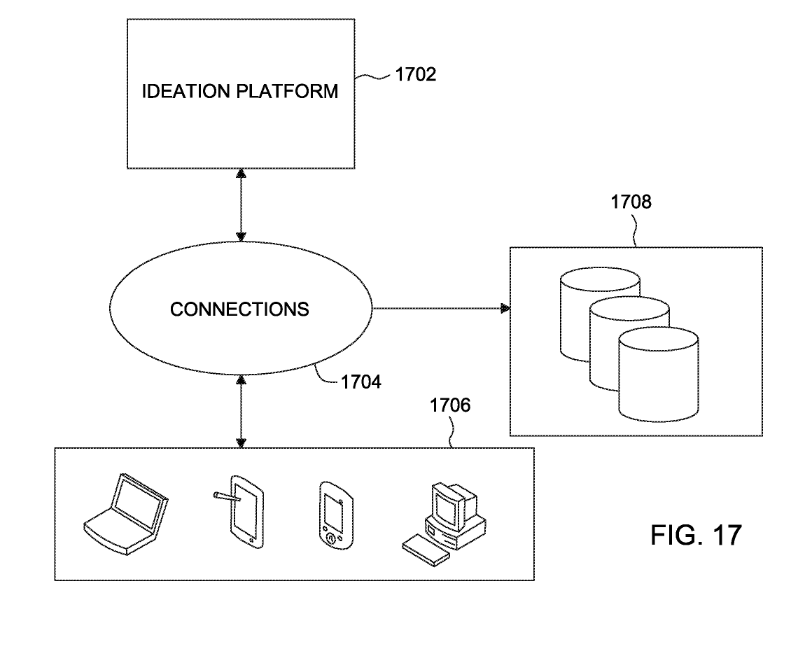

Referring to FIGS. 17 to 19, the ideation platform will now be described in more detail. In FIG. 17, there is illustrated an ideation platform 1702. The ideation platform 1702 may be accessible remotely from any one of a plurality of devices 1706 over connections 1704. The devices 1706 may comprise any processor-based device, such as a personal computer, a tablet, a smart phone, or the like, which is configured to communicate over the connections 1704. In some embodiments, the ideation platform 1702 may itself be provided directly on one of the devices 1706, either as a downloaded software application, a firmware application, or a combination thereof.

Various types of connections 1704 may be provided to allow the ideation platform 1702 to be accessed remotely. For example, the connections 1704 may comprise wire-based technology, such as electrical wires or cables, and/or optical fibers. The connections 1704 may also be wireless, such as RF, infrared, Wi-Fi, Bluetooth, and others. Connections 1704 may therefore comprise a network, such as the Internet, the Public Switch Telephone Network (PSTN), a cellular network, or others known to those skilled in the art. Communication over the network may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

One or more databases 1708 may be integrated directly into the ideation platform 1702 or any one of the devices 1706, or may be provided separately therefrom (as illustrated). In the case of a remote access to the databases 1708, access may occur via connections 1704 taking the form of any type of network, as indicated above. The various databases 1708 described herein may be provided as collections of data or information organized for rapid search and retrieval by a computer. The databases 1708 may be structured to facilitate storage, retrieval, modification, and deletion of data in conjunction with various data-processing operations. The databases 1708 may be any organization of data on a data storage medium, such as one or more servers. The databases 1708 illustratively have stored therein submitted descriptions for the creation of facets, groupings of facets to form faces, groupings of faces to form synthesized ideas, evaluation comments or other type of evaluation input, recordings of ideation processes, and stored submitted ideas.

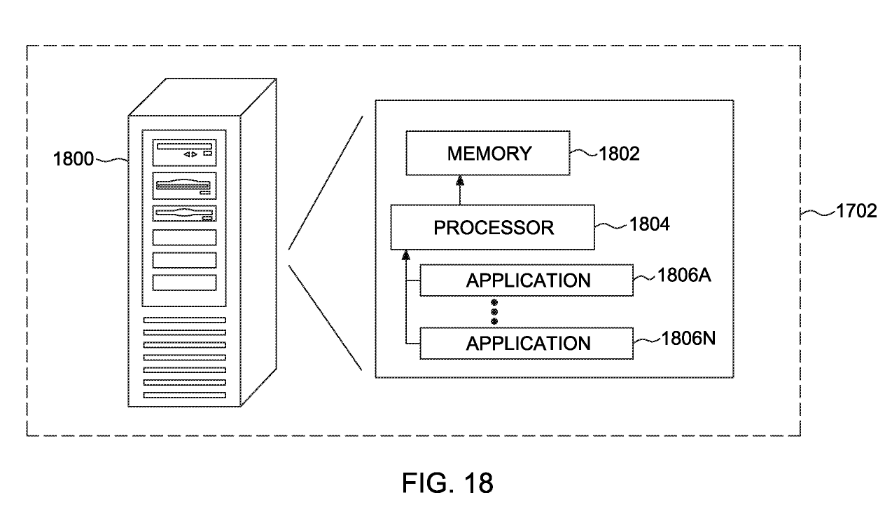

As shown in FIG. 18, the ideation platform 1702 illustratively comprises one or more server(s) 1800. For example, a series of servers corresponding to a web server, an application server, and a database server may be used. As can be appreciated, the server(s) can be separate and/or centrally located devices, or could be implemented on the processor-based devices which are used to access the ideation platform. These servers are all represented by server 1800 in FIG. 18. The server 1800 may be accessed by a user using one of the devices 1706, or directly on the system 1702 via a graphical user interface. The server 1800 may comprise, amongst other things, a plurality of applications 1806a . . . 1806n running on a processor 1804 coupled to a memory 1802. It should be understood that while the applications 1806a . . . 1806n presented herein are illustrated and described as separate entities, they may be combined or separated in a variety of ways.

The memory 1802 accessible by the processor 1804 may receive and store data. The memory 1802 may be a main memory, such as a high speed Random Access Memory (RAM), or an auxiliary storage unit, such as a hard disk, a floppy disk, or a magnetic tape drive. The memory 1802 may be any other type of memory, such as a Read-Only Memory (ROM), or optical storage media such as a videodisc and a compact disc. The processor 1804 may access the memory 1802 to retrieve data. The processor 1804 may be any device that can perform operations on data. Examples are a central processing unit (CPU), a front-end processor, a microprocessor, and a network processor. The applications 1806a . . . 1806n are coupled to the processor 1804 and configured to perform various tasks. An output may be transmitted to the devices 1706.

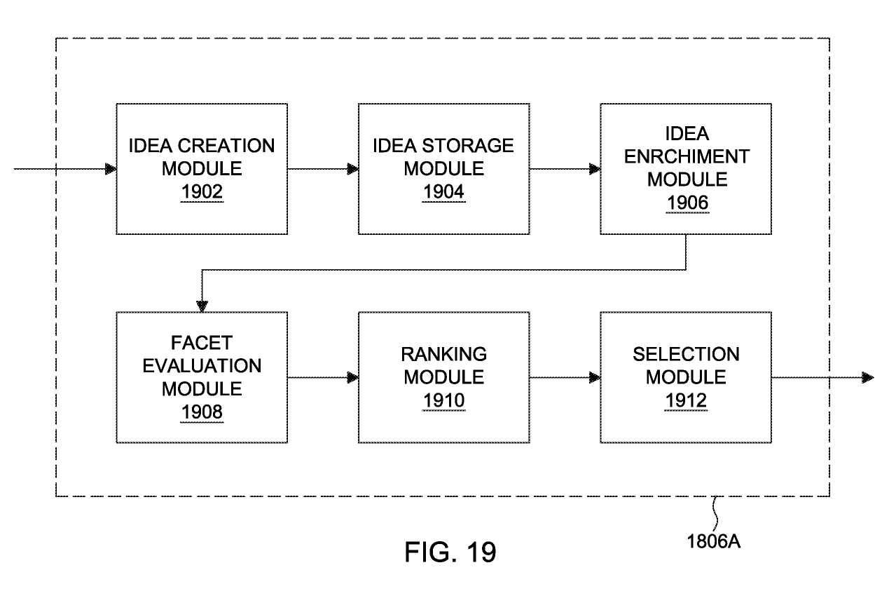

FIG. 19 is an exemplary embodiment of an application 1806a running on the processor 1804. The application 1806a illustratively comprises an idea creation module 1902, an idea storage module 1904, an idea enrichment module 1906, a facet evaluation module 1908, a ranking module 1910, and an idea selection module 1912. The idea creation module 1902 may be configured to present the individual and team workspaces to users of the ideation platform 1702 to receive idea descriptions in various expression formats, such as text, audio, video, pictures, documents and hyperlinks. The idea creation module 1902 may be configured to present the submitted facets to the user and allow manipulation thereof, as described above. The idea storage module 1904 may receive from the idea creation module 1902 the facets created by the user for storage. It may further associate at least some of those facets, for example those selected by the user, to form an individual idea. The idea enrichment module 1906 may be configured to present individual and team workspaces to users of the ideation platform to add or modify expressions of ideas in order to create enhanced ideas. The facet evaluation module 1908 may display the enriched ideas on the display screens of devices one at a time, displaying each of the facets forming said enriched ideas and allowing collaborators to vote on a pertinence of each of said facets. The ranking module 1910 can receive votes from the collaborators scoring each of the facets of each of the enriched ideas, and determine facets which are below a predetermined pertinence threshold. The idea selection module 1912 can display the enriched ideas while hiding facets determined to be below the predetermined pertinence threshold, and allow the collaborators in each team to select at least one final idea from the individual ideas created by their team. As can be appreciated, more modules may be provided to implement the steps of the ideation process as described above, such as an idea synthesizing module, a facet creation module, an idea evaluation module etc.

The idea evaluation module may be configured to provide the evaluation workspace for evaluation of the submitted ideas. If more than one evaluator is evaluating the same ideas, individual evaluation workspaces and/or collaborative evaluation workspaces may be provided. In some embodiments, each evaluator may independently evaluate the ideas on his or her own individual evaluation workspace. Individual evaluations may then be provided on the collaborative evaluation workspace for all evaluators to access. The collaborative evaluation workspace may allow further evaluation of the submitted ideas by the evaluators. In some embodiments, the combination workspace may be provided by the idea evaluation module 1906, as part of or in conjunction with the collaborative workspace. Alternatively, it may be provided separately therefrom.

The facet creation module may be configured to validate a user's understanding of the specific issue for which an idea is requested. It may also be configured to allow questions to be sent to the platform administrator or to the party requesting idea submissions. In another example, the idea synthesizing module may be configured to assign an ID to each submitted idea, for tracking purposes. The ID may be associated with a given team. The idea evaluation module may be provided in an application separate from the application comprising the facet creation module and the idea synthesizing module 1904.

In some embodiments, additional modules may also be provided, within application 1806a or separately therefrom in another application 1806n. For example, an administrative module may be provided to allow the higher access-right users to view the ideation process in progress. The administrative module may be connected to the facet creation module 1902 in order to view each team's idea creation process. The administrative module may allow updates or other information to be provided to some or all of the teams during the competition.

In another example, a registration module may be provided to allow users to create an account for access to the ideation platform 1702. The registration module may also allow users to join/form teams and/or to select a challenge/contest/issue for participation. The registration module may provide users with information regarding contests or challenges, such as rules and regulations, timing (i.e. start and stop time/date), and the specifics of the contest or challenge. For example, a challenge may be set to begin at a fixed time and all participants are to participate concurrently, with a time limit for submitting the ideas. There may be a limit to the number of ideas that any given team may submit for a given contest. Other types of rules or regulations may also apply.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system.

The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A method for collaborative ideation using a plurality of network-connected processor-based devices having display screens, each processor-based device being operated by one of a plurality of collaborators organized into one or more teams, the method comprising the steps of:
a) providing an idea creation graphical user interface (GUI) on the display screens of the processor-based devices, allowing the collaborators to individually describe ideas through the creation of facets comprising digital files in a plurality of expression formats;
b) receiving facets created by each of the collaborators and associating at least some of said facets to form individual ideas;
c) providing an idea enrichment GUI on the display screens of the processor-based devices in a team, displaying the individual ideas created by said team one at a time, and allowing the collaborators in the team to add or modify facets of the individual ideas created by each collaborator of the team to enrich said individual ideas and form enriched ideas;
d) providing a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
e) receiving votes from the collaborators scoring each of the facets of each of the enriched ideas, and determining facets which are below a predetermined pertinence threshold; and
f) providing an idea selection GUI on the display screen of at least one of the processor-based devices in each team, displaying the enriched ideas while hiding the facets determined to be below the predetermined pertinence threshold, and allowing the collaborators in each team to select at least one final idea from the enriched individual ideas created by their team.

2. The method according to claim 1, wherein displaying each of the facets forming the enriched idea comprises displaying a visual summary of each facet separately in a form of a widget, the widget being selectable to allow access to detailed contents of the facet.

3. The method according to claim 1, wherein displaying the enriched ideas comprises displaying a visual summary of the enriched ideas, the visual summary comprising a visual indication of a total number of facets of each expression format used to form the enriched ideas.

4. The method according to claim 1, wherein displaying an enriched idea on the display screen comprises grouping together facets corresponding to a same expression format, synthesizing the enriched idea into a three-dimensional (3D) geometric shape using the facets, with each face of the 3D geometric shape comprising one group of facets of the same expression format, and displaying the 3D geometric shape on the display screen.

5. The method according to claim 4, wherein each face of the geometric shape is selectable and, upon selecting a face, each of the facets in the group of facets corresponding to said face are displayed separately on the display screen.

6. The method according to claim 1, wherein the expression formats comprise a group consisting of at least: text, photos, documents, audio, video, and hyperlinks.

7. The method according to claim 1, wherein the idea enrichment GUI displays each of the facets forming the individual ideas on each of the processor-based devices, the idea enrichment GUI updating the display of each of the facets on all of the processor-based devices in real time, as facets are added or modified on any one the processor-based devices.

8. The method according to claim 1, wherein in step a), the idea creation GUI allows collaborators to respectively create individual ideas concurrently with other collaborators.

9. The method according to claim 1, wherein in step d), the facet evaluation GUI allows collaborators to respectively vote on each of the facets forming the enriched ideas, concurrently with other collaborators.

10. The method according to claim 1, wherein in step d), the facet evaluation GUI is personalized on each of the processor-based devices, whereby the facet evaluation GUI only allows voting on facets created or modified by collaborators on other ones of the processor-based devices.

11. The method according to claim 1, further comprising the step of, for each team, submitting the at least one final idea to a jury for evaluation or selection among final ideas submitted by all teams.

12. The method according to claim 1, further comprising the step of, prior to step f), providing an idea modification GUI on the display screen of at least one of the processor-based devices, the idea modification GUI allowing enriched ideas to be modified or duplicated.

13. (canceled)

14. The method according to claim 1, wherein steps a) or c) further comprise providing an idea editing GUI on the display the processor-based devices, the idea editing GUI allowing facets of individual or enriched ideas to be selectively modified, duplicated or hidden.

15. (canceled)

16. The method according to claim 1, wherein in steps a) or c), the idea creation and enrichment GUIs allow collaborators to create facets which are stored in a facet database, and allows collaborators to select which of their stored facets to add to individual or enriched ideas.

17. The method according to claim 1, further comprising the step of, prior to step f), providing an idea evaluation GUI on each of the processor-based devices, the idea evaluation GUI displaying the enriched ideas one at a time while hiding the facets determined to be below the predetermined pertinence threshold, and allowing each of the collaborators in the team to numerically vote on predetermined qualities of each of the enriched ideas as a whole, wherein step f) comprises ranking the enriched ideas according to an overall numerical vote by the team, and displaying the enriched ideas for selection ordered by said ranking.

18. The method according to claim 1, wherein step f) further comprises allowing a team leader to provide a holistic evaluation of each of the enriched ideas, ranking the enriched ideas according to the holistic evaluation, and displaying the enriched ideas for selection ordered by said ranking.

19. The method according to claim 1, wherein time restrictions are imposed on the collaborators for completing steps a) through f), said time restriction comprising a global time restriction for completing all of steps a) through f), individual time restrictions for completing at least some of steps a) through f) individually, or both.

20. (canceled)

21. (canceled)

22. The method according to claim 1, wherein displaying each of the facets forming the individual or enriched ideas comprises color-coding the facets according to their expression format.

23. A system for providing a collaborative ideation platform on a plurality of network-connected processor-based devices having display screens, each processor-based device being operated by one of a plurality of collaborators organized into teams, the system comprising a server having a processor and memory comprising:
an idea creation module configured to provide an idea creation GUI on the display screen of the processor-based devices, allowing the collaborators to individually describe ideas through the creation of facets comprising digital files in a plurality of expression formats;
an idea storage module configured to receive facets created by the collaborators, associate said facets to form individual ideas, and store the facets and the individual ideas in a database;
an idea enrichment module configured to provide an idea enrichment GUI on the display screens of the processor-based devices in a team, displaying the individual ideas created by said team one at a time, and allowing the collaborators in the team to add or modify facets of the individual ideas created by the team to enrich said individual ideas and form enriched ideas;
a facet evaluation module configured to provide a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
a ranking module configured to receive votes from the collaborators scoring each of the facets of each of the enriched ideas, and determine facets which are below a predetermined pertinence threshold; and
an idea selection module configured to provide an idea selection GUI on the display screen of at least one of the processor-based devices in each team, displaying the enriched ideas while hiding facets determined to be below the predetermined pertinence threshold, and allowing the collaborators in each team to select at least one final idea from the individual ideas created by their team.

24. A non-transient computer readable medium having stored thereon instructions for causing a computer to:
provide an idea creation GUI on display screens of a plurality of network-connected processor-based devices, each processor-based device being operated by one of a plurality of collaborators organized into teams, the idea creation GUI allowing the collaborators to describe ideas through the creation of facets comprising digital files in a plurality of expression formats;
receive facets created by the collaborators, associate said facets to form individual ideas, and store the facets and the individual ideas in a database;
provide an idea enrichment GUI on the display screens of the processor-based devices in a team, displaying the individual ideas created by said team one at a time, and allowing the collaborators in the team to add or modify facets of the individual ideas created by the team to enrich said individual ideas and form enriched ideas;
provide a facet evaluation GUI on the display screens of the processor-based devices in the team, displaying the enriched ideas created by said team one at a time, and for each of the enriched ideas, displaying each of the facets forming said enriched idea and allowing collaborators to vote on a pertinence of each of said facets;
receive votes from the collaborators scoring each of the facets of each of the enriched ideas, and determine facets which are below a predetermined pertinence threshold; and
provide an idea selection GUI on the display screen of at least one of the processor-based devices in each team, displaying the enriched ideas while hiding facets determined to be below the predetermined pertinence threshold, and allowing the collaborators in each team to select at least one final idea from the individual ideas created by their team.
